(19) United States
(12) Patent Application Publication
(10) Pub. No.: US 2019/0145592 A1
(43) Pub. Date: May 16, 2019

(54) SOLAR POWERED RECYCLING AND WASTE STATION

(71) Applicants: Greg Lawson, Hixson, TN (US); Keith O. Warren, Auburn, AL (US); Keane O. Warren, Auburn, AL (US)

(72) Inventors: Greg Lawson, Hixson, TN (US); Keith O. Warren, Auburn, AL (US); Keane O. Warren, Auburn, AL (US)

(21) Appl. No.: 16/231,740

(22) Filed: Dec. 24, 2018

Related U.S. Application Data
(63) Continuation-in-part of application No. 14/305,706, filed on Jun. 16, 2014, now Pat. No. 10,160,596.
Application No. 14/305,706 is a continuation-in-part of application No. 13/361,608, filed on Jan. 30, 2012, now abandoned.

(51) Int. Cl. F21S 9/03; H02J 7/35; H02J 7/04; F21S 8/08; H02S 40/38

(52) U.S. Cl. CPC F21S 9/035; H02J 7/35; H02S 40/38; F21S 8/086; H02J 7/045

(57) ABSTRACT

A solar powered lighting system, and a method of controlling the system, the method including monitoring a voltage level of a solar panel in the solar powered lighting system, monitoring a voltage level of a battery in the solar powered lighting system, controlling the solar panel to charge the battery when the voltage level of the solar panel is above a predetermined charging threshold, controlling the battery to power one or more lights of the solar powered lighting system when the voltage level of the solar panel is below a predetermined charging threshold and the voltage level of the battery is above a predetermined operating threshold, and suspending powering of the one or more lights when the voltage level of the battery is below the predetermined operating threshold.

### CROSS-REFERENCE TO RELATED APPLICATIONS

This application is a continuation-in-part of U.S. patent application Ser. No. 14/305,706, filed on Jun. 16, 2014, which is a continuation-in-part of U.S. patent application Ser. No. 13/361,608, filed on Jan. 30, 2012, the contents of which are incorporated by reference herein in its entirety.

### STATEMENT REGARDING FEDERALLY-SPONSORED RESEARCH OR DEVELOPMENT

Not Applicable

### BACKGROUND OF THE INVENTIVE CONCEPT

### 1. Field of Invention

The present general inventive concept relates to the temporary storage of refuse prior to collection for permanent disposal. More particularly, the present general inventive concept relates to a refuse container support apparatus capable of accommodating features in accordance with various embodiments disclosed herein.

### 2. Description of the Related Art

Refuse container holders of various kinds are known in the art. For instance, U.S. Pat. No. 2,929,512 discloses a garbage can rack to support a garbage can by a handle disposed within an upwardly opening yoke on the top of a post. Prior art racks that support an elevated garbage can primarily depend on the garbage can's side handles for support. Thus, garbage cans without side handles are not accommodated by those prior art racks. What is needed is a refuse container support apparatus that supports an elevated refuse container in a vertical position without relying on any side handles of the refuse container.

Further, prior art refuse container holders are limited in that they only support a refuse container. In today's modern age, there exists a need for a refuse container that is also capable of other applications. For instance, what is desired is a refuse container support apparatus that can also display an elevated sign, viewable from a substantial distance away from the support apparatus. Moreover, what is desired is a refuse container support apparatus capable of using solar power to illuminate an area immediately adjacent to the support apparatus.

### BRIEF SUMMARY OF THE INVENTIVE CONCEPT

The present general inventive concept provides a refuse container support apparatus that supports an elevated refuse container in a substantially vertical position without relying on any side handles of the refuse container.

Additional aspects and advantages of the present general inventive concept will be set forth in part in the description which follows, and, in part, will be obvious from the description, or may be learned by practice of the present general inventive concept.

The foregoing and/or other aspects and advantages of the present general inventive concept may be achieved by an elongated post member including a first end and a second end, with the first end disposed to support the second end above the ground. One or more foot members are coupled to the post member between the first and second ends to at least partially support a refuse container above the ground, and one or more attachment bars are provided to removably couple a refuse container to the post member from within the interior of the refuse container.

The first end of the post member can be inserted into the ground to support the post member in a substantially vertical manner, with one or more foot members disposed at a selected distance from the first end such that the one or more foot members remain elevated above the ground when the first end is disposed in the ground. Alternatively, the present general inventive concept can also be achieved by including a substantially flat base member coupled to the post member's first end such that the base member supports the post member in a substantially vertical manner. One or more wheels can be coupled to a perimeter edge of the base member. The base member and apparatus can have dimensions such that at least six hundred pounds of force applied to the post member at a height of six feet is required to overturn the apparatus.

One or more fasteners can be included to penetrate a refuse container and removably couple the one or more attachment bars and a refuse container to the post member.

One or more static bars can be coupled to the post member between the one or more foot members and the post member's second end. The one or more attachment bars can be removably coupled to the one or more static bars by the one or more fasteners. One or more spacers can couple the one or more static bars to the post member.

One or more sign retaining members can be coupled to the post member to receive and display a sign. A substantially flat top member can be coupled to the second end of the post member such that the top member is substantially parallel to the ground. A solar panel can be coupled to the top member and a light can be coupled to the post member in electrical communication with the solar panel.

One or more windows can be disposed in the post member, with a light disposed within the post member, proximate the one or more windows. A reflective material can be coupled to an inside surface of the post member, proximate the one or more windows.

The foregoing and/or other aspects and advantages of the present general inventive concept may also be achieved by including at least one surround member coupled to and supported by the one or more static bars and one or more foot members to receive and support a refuse container.

The foregoing and/or other aspects and advantages of the present general inventive concept may also be achieved by including a fixed cover attached to the surround member and a gate member attached to the surround member in a manner allowing a refuse container to be moved horizontally into and out of the surround member. The surround member and gate member may include indicia or a portion configured to display indicia, such as a descriptive plate, name, symbol or similar label, welded, cast, molded or otherwise integrated into the gate member and one or more panels of the surround member.

The foregoing and/or other aspects and advantages of the present general inventive concept may also be achieved by providing a solar powered lighting system including one or more lights, a battery configured to selectively power the one or more lights, a solar panel configured to selectively charge the battery, and a system control circuit to monitor voltage levels of the battery and the solar panel, to control the battery to power the one or more lights according to the voltage level of the battery, and to control the solar panel to charge the battery according to the voltage level of the solar panel.

The foregoing and/or other aspects and advantages of the present general inventive concept may also be achieved by providing a method of controlling a solar powered lighting system, the method including monitoring a voltage level of a solar panel in the solar powered lighting system, monitoring a voltage level of a battery in the solar powered lighting system, controlling the solar panel to charge the battery when the voltage level of the solar panel is above a predetermined charging threshold, controlling the battery to power one or more lights of the solar powered lighting system when the voltage level of the solar panel is below a predetermined charging threshold and the voltage level of the battery is above a predetermined operating threshold, and suspending powering of the one or more lights when the voltage level of the battery is below the predetermined operating threshold.

Other features and aspects may be apparent from the following detailed description, the drawings, and the claims.

### BRIEF DESCRIPTION OF THE SEVERAL VIEWS OF THE DRAWINGS

The following example embodiments are representative of example techniques and structures designed to carry out the objects of the present general inventive concept, but the present general inventive concept is not limited to these example embodiments. In the accompanying drawings and illustrations, the sizes and relative sizes, shapes, and qualities of lines, entities, and regions may be exaggerated for clarity. A wide variety of additional embodiments will be more readily understood and appreciated through the following detailed description of the example embodiments, with reference to the accompanying drawings in which:

FIG. 1A illustrates a front view of an example embodiment of the present general inventive concept with two attached refuse containers;

FIG. 1B illustrates a side view of the example embodiment of FIG. 1A;

FIG. 2A illustrates a front view of the example embodiment of FIG. 1A, without the attached refuse containers;

FIG. 2B illustrates a side view of the example embodiment of FIG. 2A;

FIG. 3 is a more detailed illustration of a front view of the example embodiment of FIG. 2A with the first end of the post member disposed in the ground;

FIG. 4A illustrates front view of another example embodiment of the present general inventive concept with one attached surround member;

FIG. 4B is a more detailed illustration of a front view of an example embodiment capable of accommodating a surround member, but without the surround member attached;

FIG. 4C illustrates a bottom view of an example embodiment surround member in accordance with various embodiments of the present general inventive concept;

FIG. 5 is a more detailed illustration of an example embodiment of the present general inventive concept, showing a top member, a solar panel, a light, and windows;

FIG. 6 illustrates a front view of an example embodiment of the present general inventive concept with two surround members, a top member, a solar panel, a light, and windows;

FIG. 7 illustrates a perspective view of an example embodiment of the present general inventive concept with a conventional grass trimmer operating beneath a secured refuse container;

FIG. 8 illustrates a front view of an example embodiment of the present general inventive concept with a portable base unit;

FIG. 9 illustrates a front view of an example embodiment of the present general inventive concept having two square surround members with fixed covers and hinged gate members;

FIG. 10 illustrates a three-dimensional view of the example embodiment of FIG. 9;

FIGS. 11A-B illustrate a post member equipped with a solar powered lighting system according to an example embodiment of the present general inventive concept;

FIG. 12 is a schematic illustration of a solar powered lighting system control circuit according to an example embodiment of the present general inventive concept;

FIG. 13 illustrates a protective casing for a solar powered lighting system control circuit according to an example embodiment of the present general inventive concept; and

FIG. 14 illustrates a method of controlling a solar power lighting system according to an example embodiment of the present general inventive concept.

### DETAILED DESCRIPTION OF THE INVENTIVE CONCEPT

Reference will now be made to various example embodiments of the present general inventive concept, examples of which are illustrated in the accompanying drawings and illustrations. The example embodiments are described herein in order to explain the present general inventive concept by referring to the figures.

The following detailed description is provided to assist the reader in gaining a comprehensive understanding of the structures and fabrication techniques described herein. Accordingly, various changes, modification, and equivalents of the structures and fabrication techniques described herein will be suggested to those of ordinary skill in the art. The progression of fabrication operations described are merely examples, however, and the sequence type of operations is not limited to that set forth herein and may be changed as is known in the art, with the exception of operations necessarily occurring in a certain order. Also, description of well-known functions and constructions may be simplified and/or omitted for increased clarity and conciseness.

Note that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. Spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

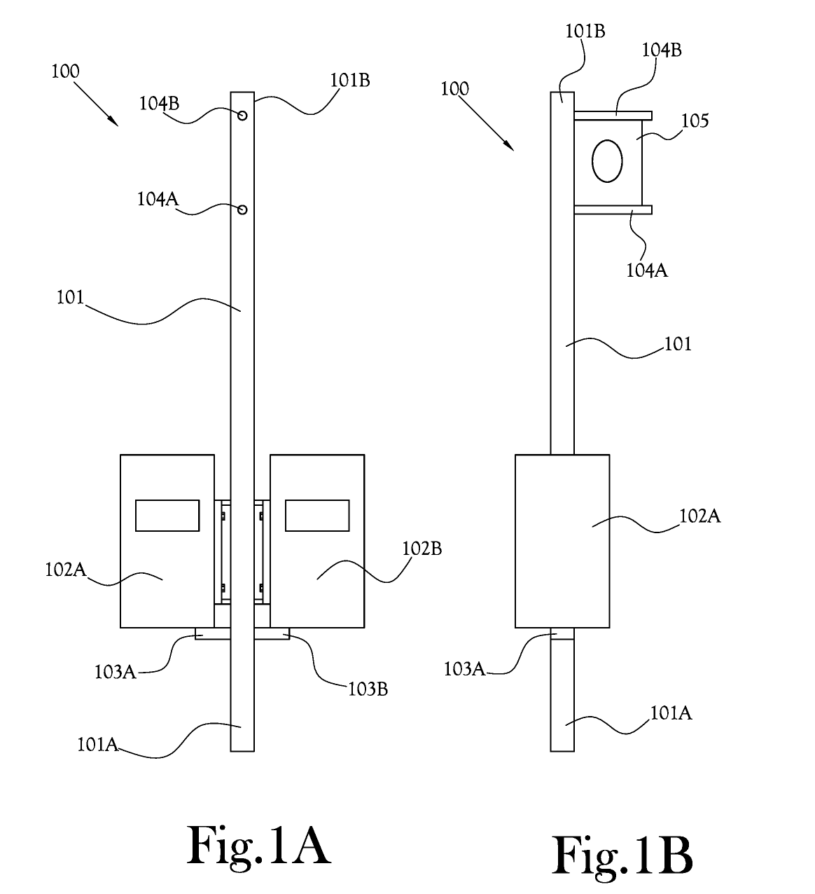

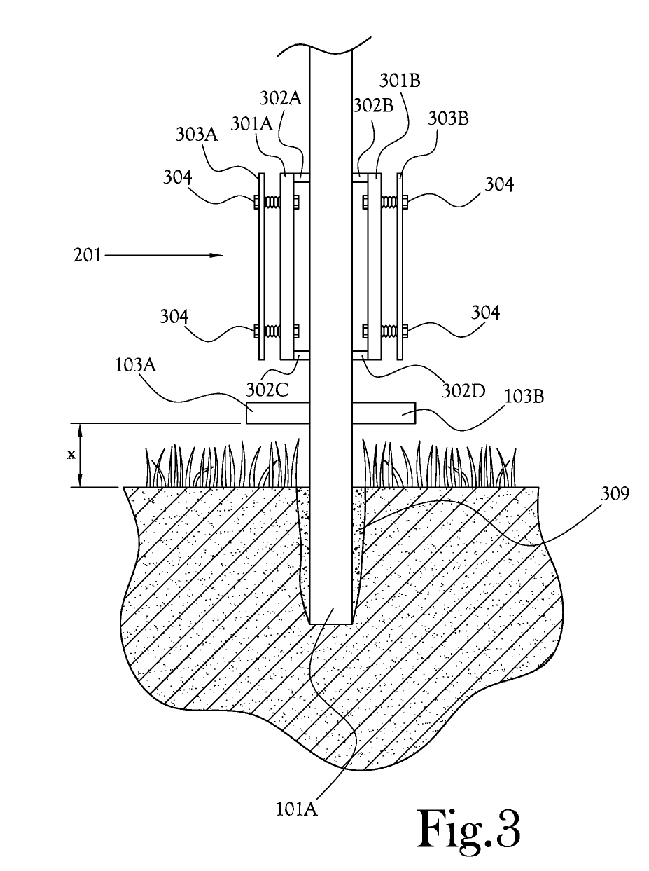

One example of a refuse container support apparatus 100, in accordance with various embodiments of the present general inventive concept is shown generally in FIGS. 1-9. Referring to FIGS. 1A & 1B, an elongated post member 101 is provided to support one or more refuse containers 102A & 102B. The elongated post member 101 in the illustrated embodiment includes a first end 101A and a second end 101B, and can be mounted in the ground so as to be substantially vertical. To that extent, the first end 101A can be inserted into a pre-sized hole in the ground. One of skill in the art will understand that filler material is typically used when disposing an object of this size vertically in the ground. Accordingly, in some embodiments, cement can be introduced into the pre-sized hole, around the inserted end 101A to provide additional support. FIG. 3 illustrates an example embodiment with the post member's first end 101A disposed in the ground and surrounded by cement 309. Other conventional filler materials can also be used without departing from the scope or spirit of the present general inventive concept.

Foot members 103A & 103B can be coupled to the post member 101 in a substantially perpendicular arrangement to at least partially support a refuse container in an elevated, substantially vertical position. In some embodiments, the foot members 103A & 103B are integrally formed with the post member 101. In other embodiments, the foot members 103A & 103B can be coupled to the post member 101 with conventional fasteners. In yet other embodiments, the foot members 103A & 103B can be welded to the post member 101.

The first end 101A of the post member 101 is preferably inserted into the ground to a point where the foot members 103A & 103B can be elevated to an extent so as to accommodate operation of a conventional grass trimmer underneath. FIG. 3 shows an example embodiment with the post member's first end 101A inserted into the ground, with x representing the distance between the ground and the foot members 103A & 103B. In some embodiments, the elongated post member 101 spans a length of fourteen (14) feet. In some embodiments, the first two (2) feet of the post member's first end 101A are inserted in the ground. In some embodiments, the foot members 103A & 103B are disposed approximately thirty (30) inches from the first end 101A and span a length of approximately nine (9) inches. Thus, in some embodiments, the foot members 103A & 103B are elevated approximately six (6) inches above the ground, so as to accommodate a conventional grass trimmer underneath. One of skill in the art will understand that the example dimensions discussed herein are non-limiting, and any of a number of other dimensions may be provided. Accordingly, different dimensions may be readily substituted for those which are disclosed herein without departing from the scope or spirit of the present general inventive concept.

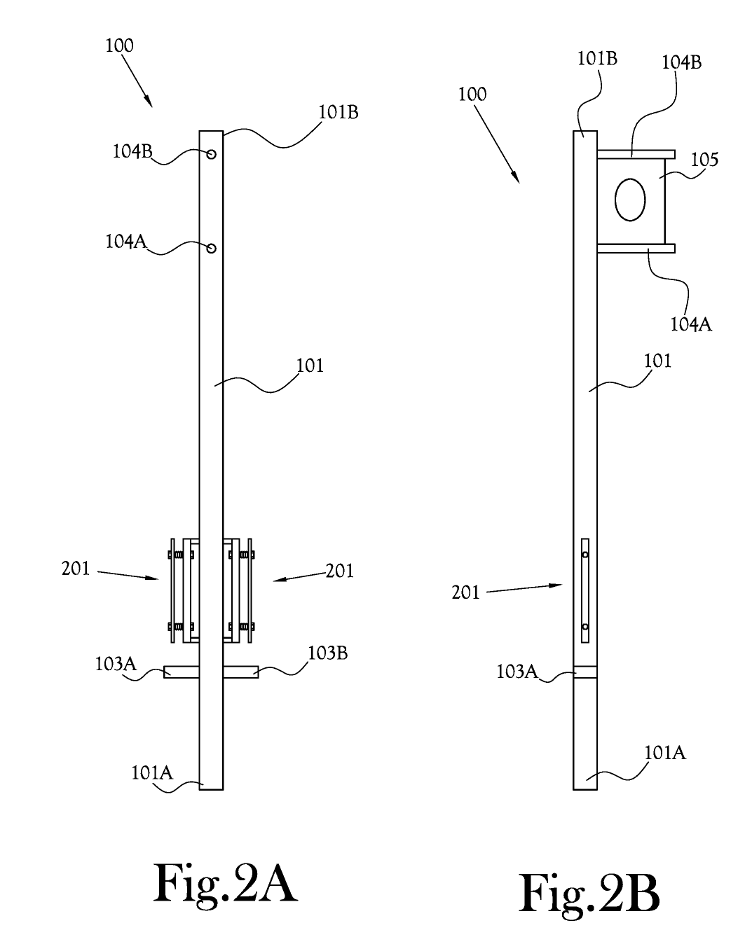

Referring to FIGS. 2A-3, components 201 are provided to secure a refuse container 102 to the post member 101, proximate the foot members 103A & 103B, in accordance with various embodiments of the present general inventive concept. Static bars 301A & 301B can be coupled to and disposed substantially parallel to the post member 101. In some embodiments, the static bars 301A & 301B can be approximately two (2) feet in length. One skilled in the art will understand that this example dimension is non-limiting. In the illustrated embodiment, the static bars 301A & 301B are coupled to the post member 101 using welded spacers 302A-D. In other embodiments, the spacers 302A-D can be coupled to the post member 101 and static bars 301A & 301B using conventional fasteners. In other embodiments, the static bars 301A & 301B and spacers 302A-D can be integrally formed with the post member 101. In other embodiments (not illustrated), the static bars 301A & 301B can be disposed directly on the elongated post member 101. Stated differently, static bars 301A & 301B can be coupled directly to or integrally formed with the post member 101 without spacers.

The attachment bars 303A & 303B are removably coupled to the static bars 301A & 301B. In some embodiments, the attachment bars 303A & 303B can be substantially equal in length to the static bars 301A & 301B. In the illustrated embodiment, the attachment bars 303A & 303B are removably coupled to the static bars 303A & 303B by way of conventional fasteners 304.

In some embodiments (not illustrated), the attachment bars 303A & 303B can engage directly with the post member 101. Stated differently, the function served by the static bars 301A & 301B can be incorporated directly into the post member 100 such that the conventional fasteners 304 removably couple the attachment bars 303A & 303B directly to the post member 101.

The post member 101 can be any type of conventional material, but should be strong enough to support a filled refuse container, and durable enough to withstand nature's elements. One such material that has been used with success is, for example, steel. Likewise, in some embodiments, the foot members 103A & 103B, static bars 301A & 301B, spacers 302A-D, and attachment bars 303A & 303B are all substantially comprised of steel. One skilled in the art will recognize that the particular material used for each of the above-mentioned components is non-limiting, and may be substituted for without departing from the scope or spirit of the present general inventive concept.

Referring now to FIGS. 1A-3, the refuse containers 102A & 102B can be removably coupled to the post member 101 using the components illustrated at 201. Specifically, the refuse containers 102A & 102B can be disposed on top of, and at least partially supported by, the foot members 103A & 103B. Attachment bars 303A & 303B can be removably coupled to the static bars 301A & 301B from within the interior of the refuse containers 102A & 102B, thereby securing the refuse containers 102A & 102B to the static bars 301A & 301B and, ultimately, the post member 101. Stated differently, the attachment bars 303A & 303B can be coupled to the static bars 301A & 301B from within the interior of the refuse containers 102A & 102B by virtue of conventional fasteners 304 penetrating the refuse containers 102A & 102B. Importantly, the present general inventive concept is not confined to the use of two refuse containers 102A & 102B and means for supporting such. In other embodiments, the present general inventive concept can be comprised of only one set of refuse container support components 201.

In FIGS. 1A-2B, two sign retaining members 104A & 104B are included, proximate the second end 101B of the post member 101. Each sign retaining member 104A & 104B in the illustrated embodiments is an elongated pole or rod. An accompanying sign 105 can be coupled to both sign retaining members 104A & 104B such that the sign 105 is fully displayed. Stated differently, the sign 105 in the illustrated embodiments is coupled to the sign retaining members at all four corners of the sign 105. In some embodiments, only one sign retaining member 104B can be used. In some embodiments, the lower sign retaining member 104A can be above eye level, so as to prevent injury and accommodate viewing of the sign 105 from a substantial distance away from the post member 101. In some embodiments, the lower sign retaining member 104A can be disposed at a height such that it cannot be grabbed by the average individual. In some embodiments, the lower sign retaining member 104A can be elevated approximately nine and one-half (9½) feet above the ground.

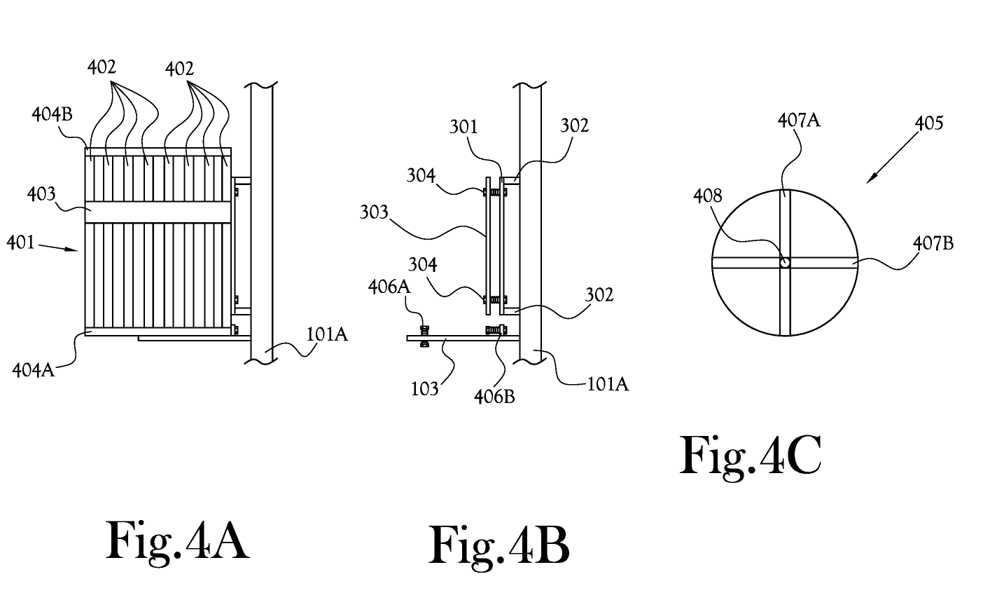

Referring now to FIGS. 4A-4C, in some embodiments of the present general inventive concept, a surround member 401 can be coupled to the post member 101, for receiving and supporting a refuse container. In the illustrated embodiment, the surround member 401 is comprised of several annularly spaced vertical panels 402 disposed on a substantially circular base portion 405. A circumferential middle panel 403, top panel 404B, and bottom panel 404A are also included in the illustrated embodiment. In some embodiments, the surround member 401 can be generally comprised of steel. One of skill in the art will recognize that the composition of the surround member 401 is not critical to the present general inventive concept. Accordingly, materials other than steel can be readily substituted without departing from the scope or spirit of the present general inventive concept.

In some embodiments, the surround member's circular base 405 can have a diameter of approximately twenty-seven and one-fourth (27¼) inches. In some embodiments, the surround member's vertical panels 402 can be thirty-five (35) inches tall and one and one-half (1½) inches wide. In the illustrated embodiment, vertical panels 402 are selectively positioned to allow for open intervals between each of the vertical panels 402. One of skill in the art will understand that the above-mentioned example dimensions are meant to be non-limiting, and may be substituted for without departing from the scope or spirit of the present general inventive concept.

In some embodiments, the surround member 401 can be coupled to the post member 101 using a foot member 103, a static bar 301, and conventional fasteners 304. FIG. 4A portrays a surround member 401 partially supported by the foot member 103 and secured against the static bar 301 with conventional fasteners 304 penetrating one of the annularly spaced vertical panels 402. In the illustrated embodiment, spacers 302 are used to couple the static bar 301 to the post member 101. Contrastingly, FIG. 4B illustrates another embodiment, wherein an attachment bar 303 can be coupled to the static bar 301 with two conventional fasteners 304 disposed in an open interval between two vertical panels 402, one above the circumferential middle panel 403 and one below it, thereby securing the surround member 401 to the post member 101. In the embodiments illustrated in FIGS. 4A & 4B, foot member fasteners 406A & 406B are also used to secure the surround member 401 to the foot member 103. Foot member 103, in the present embodiment, is designed to support the surround member 401 by receiving one of the cross members 407A, 407B of the surround member's circular base portion 405 on top of it, in a substantially aligned manner. In this embodiment, the foot member 103 spans a length of approximately twenty-one (21) inches, so as to provide a point of attachment for the substantial center of the surround member's circular base portion 405. Further, in the embodiment illustrated in FIG. 4B, the vertically disposed foot member fastener 406A penetrates both cross members 407A, 407B at their intersection, illustrated at 408, while the horizontal foot member fastener 406B penetrates the bottom circumferential panel 404A.

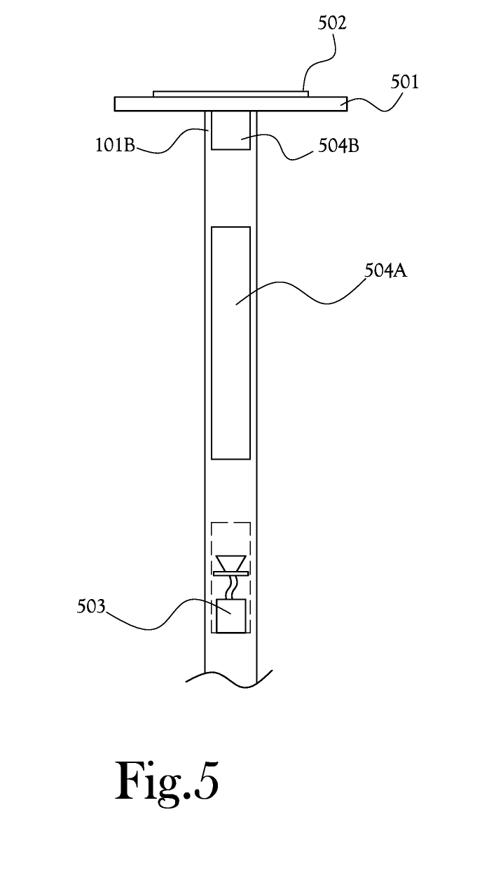

In some embodiments, the second or top end 101B of the post member 101 can include a substantially flat top member, disposed substantially perpendicular to the substantially vertical post member 101. Referring to FIG. 5, a top member 501 is perpendicularly coupled to the post member 101 by way of conventional fastening techniques, such as, for example, conventional fasteners, welding or the like. In other embodiments, the top member 501 is integrally formed with the post member 101. The top member 501 is designed for receiving and securing a solar panel 502 on the top member's surface distal the post member 101. Stated differently, a solar panel 502 sits atop top member 501 to receive solar emissions from the sun. In the illustrated embodiment, a light 503 is also included and coupled to the post member 101, proximate the second end 101B. The light 503 is in electrical communication with the solar panel 502, such that the solar panel 502 provides power to the light 503. In some embodiments, the light 503 is actuated in response to the solar panel 502 not receiving solar emissions. Stated differently, the light 503 remains off during the day while sunlight is prevalent, and is turned on in the evening when it becomes dark and the solar panel 502 is no longer receiving sunlight.

A light can be included on the present general inventive concept to illuminate the area immediately adjacent to the post member 101, and to illuminate the sign 105 such that it can be viewed at night from a substantial distance away from the post member 101. In the illustrated embodiment, the light 503 is disposed within the post member 101. In this embodiment, an access door (not illustrated) is provided in the post member 101, proximate the light 503, such that the light 503 can be accessed for maintenance, replacement, or both. In the illustrated embodiment, a halogen light bulb is used. In other embodiments, an LED light is used. One of skill in the art will understand that various types of light bulbs can be utilized without departing from the scope or spirit of the present general inventive concept, so long as the selected solar panel is capable of providing a sufficient amount of power to actuate the selected light bulb. Further, the illustrated embodiment also includes windows 504A & 504B to permit the light 503 to illuminate the immediately adjacent area. The precise number and position of the windows 504A & 504B may be selected according to the particular illuminating needs of the location of the refuse container support apparatus 100. In some embodiments, the interior surface of the post member 101, proximate the windows 504A & 504B can be covered with a reflective material (not illustrated) to increase the illuminating effect provided by the light 503. In these embodiments, reflective paint and tape have both been used with success. However, one skilled in the art will recognize that other reflective materials capable of being coupled to a substantially smooth surface may also be utilized without departing from the scope or spirit of the present general inventive concept.

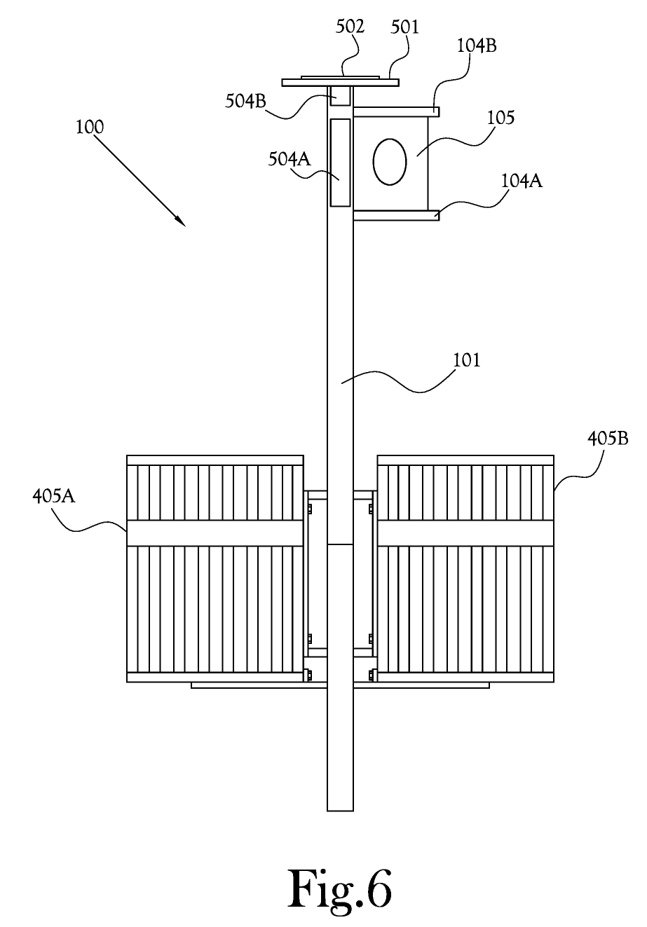

FIG. 6 illustrates a front view of an example embodiment of the present general inventive concept. The presently illustrated embodiment includes two surround members 405A, 405B; two sign retaining members 104A, 104B; a sign 105; two windows 504A, 504B proximate a light disposed inside the post member 101; a top member 501; and a solar panel 502 in electrical communication with the light. The present embodiment accommodates two refuse containers that may be received in and secured by the surround members 405A & 405B. To that extent, both a garbage container and a recycling container can be provided.

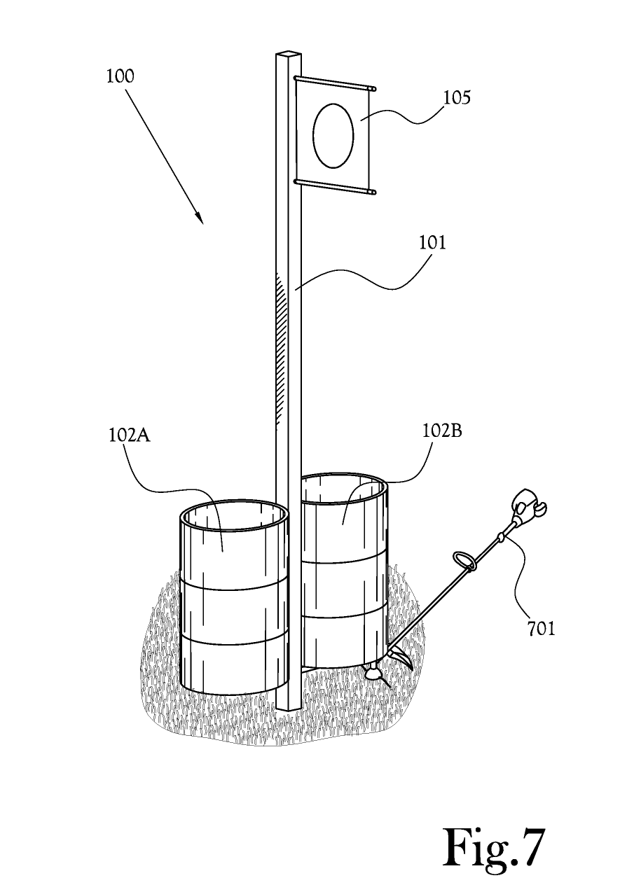

FIG. 7 illustrates a perspective view of an example embodiment of the present general inventive concept with a conventional grass trimmer 701 operating underneath an elevated, secured refuse container 102B. In the illustrated embodiment, two refuse containers 102A & 102B are both supported by the refuse container support apparatus 100 in an elevated manner. Referring also to FIG. 3, the distance×between the ground and the foot members 103A & 103B is also the distance of elevation for the secured refuse containers 102A & 102B in FIG. 7. Thus, in some embodiments of the general present inventive concept, the refuse container support apparatus 100 can accommodate two refuse containers 102A & 102B while also permitting the operation of a conventional grass trimmer 801 underneath.

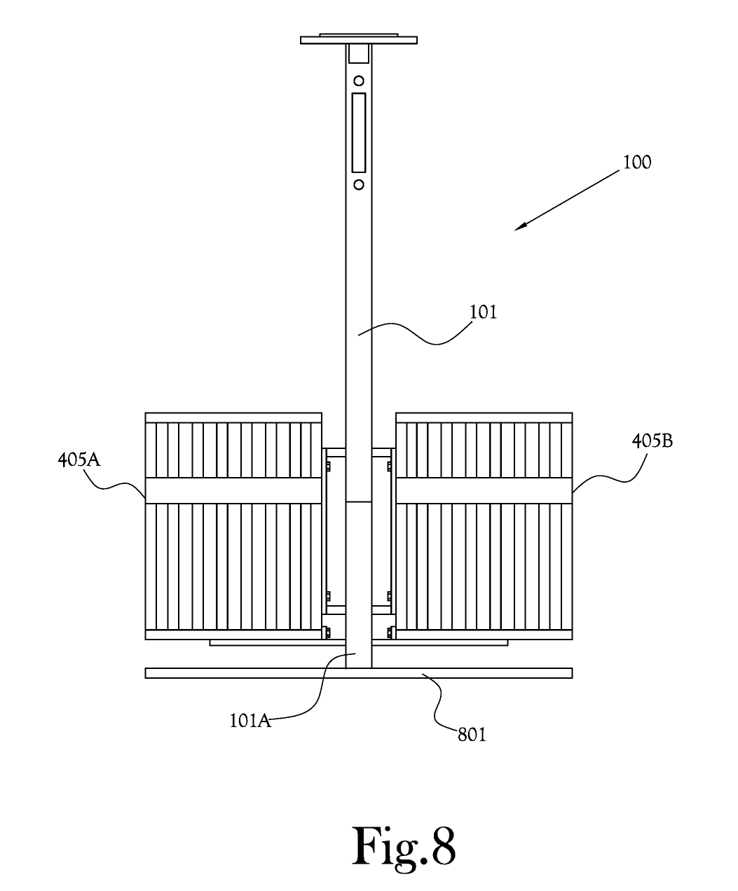

In some embodiments of the present general inventive concept, a substantially flat base member can be substantially, perpendicularly coupled to the first end 101A of the post member 101. Referring to FIG. 8, base member 801 is perpendicularly coupled to the post member 101 to provide an alternative means to vertically support the post member 101. The base member 801 can be perpendicularly coupled to the post member 101 by conventional fastening techniques, or it can be integrally formed with the post member 101. This embodiment provides a portable option to the present general inventive concept that can be used, for example, at fairs or other temporary outdoor events where permanent installation of the refuse container support apparatus 100 is not desirable. In some embodiments, one or more wheels can be coupled to the outer perimeter rim of the base member 801 such that the refuse container support apparatus 100 can be tilted and rolled across a substantially flat surface.

In some embodiments, the base member 801 can be substantially comprised of steel. In some embodiments, a one-half (½) inch steel plate is used as the base member 801. The surface area of base member 801 can vary according to the height and weight of the post member 101. For instance, one skilled in the art will understand that the tipping force required for overturning the refuse container support apparatus 100 depends on the dimensions of the base member 801, in combination with the overall weight of the apparatus 100 and the height of the tipping force being applied. In some embodiments, the base member 801 is sixty-three and one-half (63½) inches long, by twenty-eight (28) inches wide. Those skilled in the art will understand that these example dimensions are meant to be non-limiting. For example only, if the refuse container support apparatus 100 weights approximately fifteen hundred fifty (1550) pounds, the above mentioned example dimensions would provide a stabilizing presence to the extent that greater than six hundred (600) pounds of tipping force, applied at a height of approximately six (6) feet along the width axis of the base member 801, would be necessary to overturn the apparatus 100.

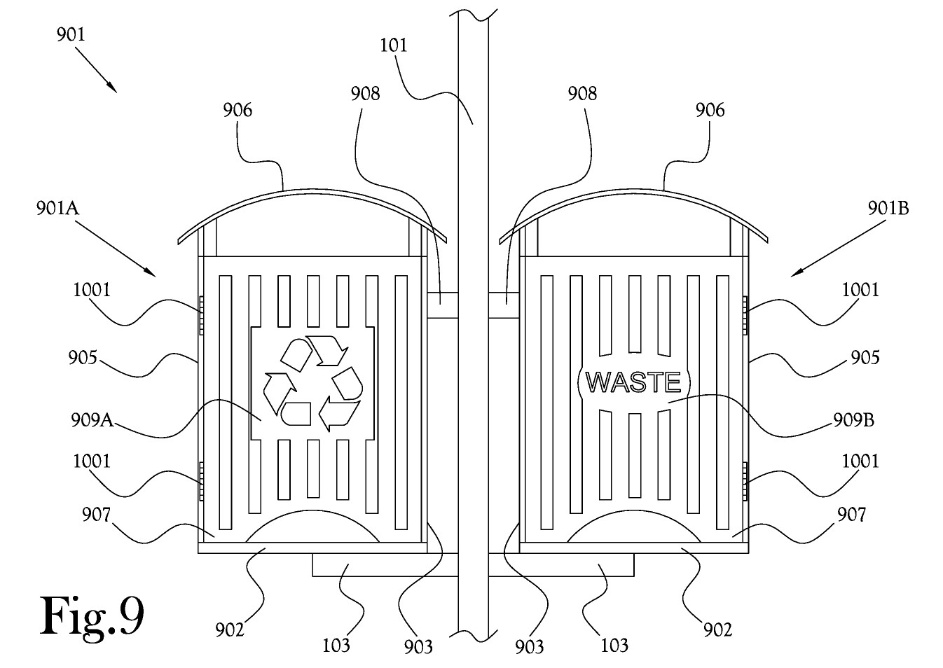

Referring now to FIGS. 9 & 10, in various example embodiments of the present general inventive concept, two surround members 901A & 901B may be coupled to the post member 101, each said surround member configured to receive and support a refuse container 102. In the example embodiment illustrated in FIGS. 9 & 10, each surround member 901 is may include a base 902, an inside panel 903, a back panel 904, an outside panel 905, and a fixed cover 906, all coupled to each other to form each surround member 901, and a gate member 907, said gate member configured to swing or slide open allowing a refuse container 102 to be inserted into and removed from the surround member 901A, 901B in a horizontal direction instead of a vertical direction. In the example embodiment illustrated in FIGS. 9 & 10, the fixed cover 906 may be an upward curving sheet of rolled steel forming a fixed cover over the interior volume of the surround member 901 as well as the enclosed refuse container 102, and forming two or more opposing openings below the fixed cover 906 and above the vertical panels of the surround member 901 and the gate member 907 sufficient to permit refuse to be dropped into the refuse container 102. In the illustrated embodiment, there are two openings below the fixed cover 906 of the surround member 901—one above the back panel 904 and the other above the gate member 907. In the illustrated embodiment, the base 902, the inside panel 903, the back panel 904, the outside panel 905, and the fixed cover 906 are cut from sheet steel and welded together to form each surround member 901. In the illustrated embodiment, the gate member 907 may be cut from sheet steel with the top edge folded at a substantially 90 degree angle to form a horizontal edge extending inwardly into the surround member 901A, 901B when the gate member 901 is closed. One skilled in the art will recognize that the previously described material used for the surround member 901 and the gate member 907 is non-limiting, and various other materials such as, for example, plastic, aluminum, fiberglass, and other suitable materials, or various combinations thereof, may be substituted for steel without departing from the scope or spirit of the present general inventive concept. In other embodiments of the present inventive concept, the base 902, the inside panel 903, the back panel 904, the outside panel 905, and the fixed cover 906 may be cast, molded or poured together to form the surround member 901 as one part. In various other example embodiments, said panels 903, 904, 905 and said gate member 907 may be comprised of parallel vertical steel bars spaced and welded to a top and bottom steel bar to form said panels and said gate member, and then welded to said base and said fixed top to form the surround member 901 as one part. In various other example embodiments, said base, said panels and said fixed cover may be attached together by means of conventional fastening techniques, such as, for example, bolts, other conventional fasteners, or the like, to form the surround member.

In the example embodiments illustrated in FIGS. 9 & 10, each inside panel 903, back panel 904, outside panel 905, and gate member 907 may be cut from a steel sheet with a bottom edge curving upward after extending horizontally a short distance from each vertical edge, straight vertical side edges, and a straight horizontal top edge, with equally spaced parallel vertical slots cut out for ventilation to form each panel or gate member. The base 902 of the surround member 901 may be cut from a square metal sheet, with equally spaced parallel slots cut out for ventilation and for drainage and with holes drilled for attachment of the surround member 901 to the foot member 103. In the illustrated embodiments, foot member fasteners 406A & 406B are used to secure the surround members 901A & 901B to the foot member 103. In the illustrated embodiments, horizontal spacer bars 908 may be welded to the post member 101 on one end and to the inside panel of the surround member 901 on the other end. In other embodiments of the present inventive concept, the surround member 901 may be attached to the post member 101 by means of any of a number of conventional fastening techniques, such as, for example, bolts, other conventional fasteners, or the like, with or without spacers. One skilled in the art will recognize that the described material used for the surround member 901 and the gate member 907 is non-limiting, and various other materials such as, for example, plastic, aluminum, fiberglass and other suitable materials may be substituted for steel without departing from the scope or spirit of the present general inventive concept.

In some embodiments of the present general inventive concept, indicia or a portion configured to display indicia such as, for example, a descriptive plate, name, symbol or similar label may be welded, cast, molded or otherwise integrated into the gate member 907 and one or more panels of the surround member 901 to identify the type of refuse container 102 located inside said surround member. Referring to the embodiment illustrated in FIGS. 9 & 10, labels 909A & 909B identifying the type of refuse container 102 located inside surround members 901A and 901B are cut and integrated into the center of the gate member 907 and the center of the back panel 904 of each surround member 901.

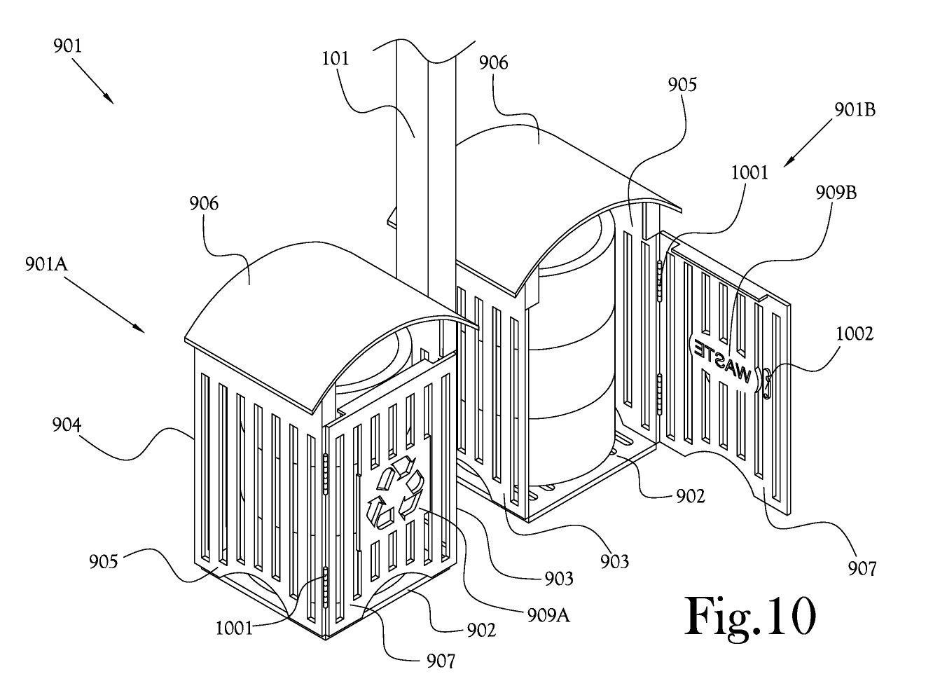

In the embodiment illustrated in FIG. 10, the gate member 907 is attached to the outside panel 905 of the surround member 901 by two conventional hinges 1001, and the other side of the gate member 907 may be latched to the inside panel 903 of the surround member 901 by means of a latch fastener 1002. In other example embodiments of the present inventive concept, the gate member 907 could be latched to the base 902 of the surround member 901 by means of a conventional latch, or the like, and the size, number and placement of the hinges and the latch could depart from the illustrated hinges and latch. The hinged gate member 907 allows the refuse container 102 to slide horizontally into and out of the surround member 901, such that sanitary personnel do not have to remove a cover from the surround member and then lift said refuse container vertically out of the enclosure to empty the contents of said refuse container.

As previously described in the discussion of FIG. 5, a solar panel and light can be provided to the post member 101 to illuminate an object or area proximate the post member 101. In various example embodiments of the present general inventive concept, such a light or plurality of lights can be utilized to illuminate one or more signs attached to the post member 101, signs or other objects proximate to post member 101, the general area proximate the post member 101, and so on. Such a solar powered light or lights may be especially valuable when being provided in remote locations, such as in large parks or on wilderness trails, in which lighted areas would be desired without spending upwards of hundreds of thousands of dollars to implement a conventional electrical power system provided by a utility company. Also, as discussed in the descriptions of various example embodiments herein, providing such a powered station in otherwise unpowered locations provides unique opportunities to provide a host of other services such as, for example, monitoring and gathering data regarding environmental conditions, passersby, and so on. As such, various example embodiments of the present general inventive concept may provide a host of different types of sensors and communication abilities to gather, store, and/or communicate such gathered data to a remote location to be analyzed in real time and/or at a later time.

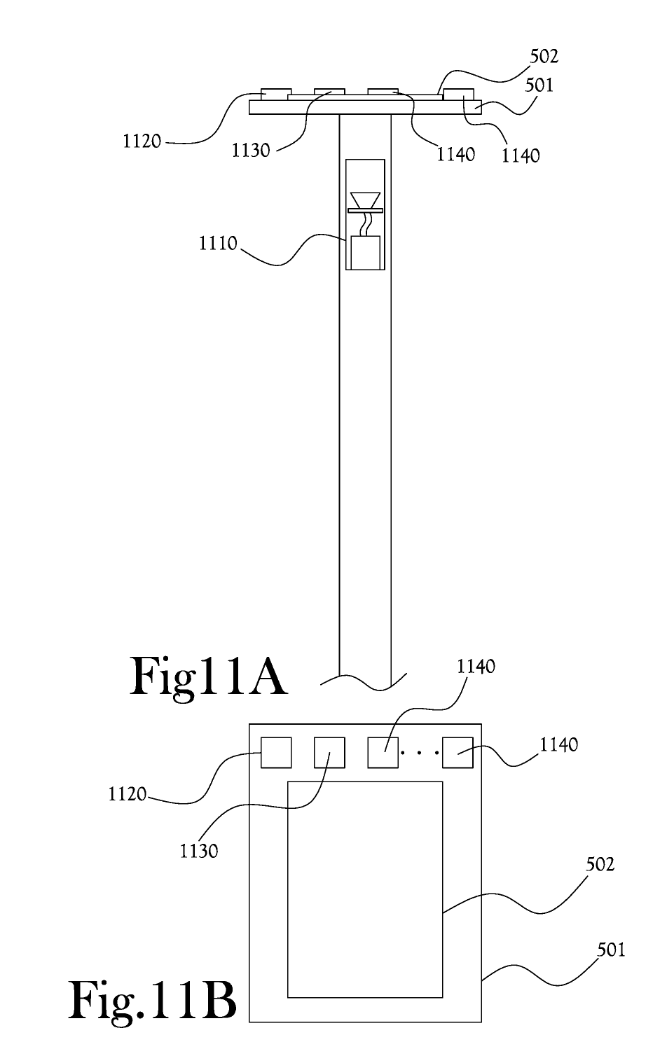

FIGS. 11A-B illustrate a post member equipped with a solar powered lighting system according to an example embodiment of the present general inventive concept. FIG. 11A illustrates an arrangement similar to the example embodiment illustrated in FIG. 5, wherein the top member 501 is provided at the second end 101B of the post member 101, and the photovoltaic solar panel 502 is provided atop the top member 501. Although the photovoltaic solar panel 502 is described as the element used for power and battery charging herein, it is understood that other types of photovoltaic elements, which may include one or more solar cells, capable of converting sunlight to electricity may be used without departing from the scope of the present general inventive concept. The solar panel 502 provides power at least some of the time to a light 1110 provided to the system, and a battery 1120 is provided to also provide power at least some of the time to the light 1110. The solar panel 502 and battery 1120 also provide power to the various components and circuitry comprising the lighting control system and peripheral components, as will be described in more detail herein. Although the light 1110 is illustrated in FIG. 11A as a single light source for simplicity and clarity of this discussion, it is understood that various different numbers of lighting elements, such as halogen bulbs, LED's, etc., may be provided to the lighted pole and overall lighting control system. In these descriptions the at least one light 1110 may be referred to as a light or as lights, and it is understood that various different example embodiments may employ any number of lights 1110. It will also be understood that the light 1110 or lights may be configured in a variety of different ways and locations. For example, the light 1110 may be provided inside the post member 101, proximate a window or other at least partially translucent or transparent portion, to provide extra protection from the environmental conditions or vandals. In some example embodiments, a plurality of lights 1110 with respective translucent or transparent windows may be provided along the length of the post member 101, and the windows may be provided on multiple sides of the post member 101 for each light. In some example embodiments, one or more antennae may also be arranged proximate to such windows in the post member 101 to transmit and receive communication signals such as those transmitted and received by a cellular communications device. Externally mounted antennae can create problems such as weather sealing issues due to the external antenna and connection wiring, complicated opening and closing the enclosed top member for maintenance, creating a target for vandalism, etc., and these problems can be overcome with the internally mounted antenna provided in various example embodiments of the present general inventive concept. By providing the antenna inside the post member 101, the fact that the unit even includes a transmitter is concealed form the public eye, along with other benefits such as protecting the transmitter/receiver circuitry. In such example embodiment, the windows will also be RF transparent. In other example embodiments, the light 1110 or lights may be attached to one or more outer surfaces of the post member 101, or to a bottom or other surface of the top member 501, and so on. It will also be understood that various different example embodiments of the present general inventive concept may include a host of physical arrangements that may differ from that illustrated in FIG. 11A without departing from the scope of the present general inventive concept. For example, the solar panel may be integrated with the top member or provided in a different configuration without a top member, and so on.

In the example embodiment illustrated in FIG. 11A, the battery 1120 and a control circuit 1130 are provided atop the top member 501 along with the solar panel 502. As previously described, various example embodiments of the present general inventive concept may provide a top member configured as a sealable hollow body that encloses these components to protect them from weather, vandalism, etc. In the various descriptions herein, the control circuit 1130 may be referred to interchangeably as a system control circuit or lighting system control circuit. FIG. 11B illustrates a top view of an example arrangement of these components, as well as additional peripheral components 1140 which may be provided in various different example embodiments of the present general inventive concept. In various example embodiments one or more of the peripheral components may be provided at different locations relative to the top member 501, attached to or inside the post member 101, or at a location remote to the post member 101 and in electrical communication with the control circuit 1130. Although the illustrated example embodiments show the discussed elements arranged on top of the top member for the sake of clarity, various example embodiments may typically include a top member that is configured as a hollow body that houses one or more of the components of the lighting system, such as the control circuitry 1130, battery 1120, a cellular communication unit, and so on. An enclosed top member may provide a more aesthetically pleasing solar powered lighting unit, and protect the componentry inside from weather, theft, vandalism, and so on. In some example embodiments one or more of the solar panels 502 may be configured to extend above the top member 501, such as on one or more posts, stems, etc., extending above the top member 501, and may be coupled to the top member 501 so as to be capable of being tilted and/or rotated toward different areas of sun exposure so that a universal design can be employed in different areas without limiting the sun exposure with a fixed design. In other example embodiments the one or more solar panels 502 may be mounted on a stem in a fixed orientation, such as at an angle to be faced toward maximum sun exposure. The control circuit 1130 is configured to control, among other things, the operation of the light 1110 or lights in a manner that will protect and prolong the life and general operational well being of the battery 1120. As providing these solar powered lighted post members in remote locations can result in difficult maintenance trips, it is desirable be able to control the lighting system in such a way that any physical visits to the structures are minimized. Also, as part of such a strategy may include using more expensive batteries that will have a longer life, it may be especially valuable to utilize the batteries in such a way as to not over strain the operation of the battery. For example, while conventional solar powered lights with batteries may simply be turned on and off according to lighting conditions, prolonged periods of no light may result in completely depleting the battery's charge repeatedly, or at least over taxing the battery. Such use shortens the life of the battery, and thus causes unwanted cost and inconvenience in maintenance and replacement of the battery, as well as potential harm to other components of the system. Example embodiments of the present general inventive concept provide a control circuit to charge and discharge the battery in an intelligent way according to the various environmental conditions and other factors encountered by the solar powered lighting system. Also, as previously mentioned, providing such power to a remote area provides opportunities to gather a host of other data, and therefore proper power management will prolong the life and operational ability of the more expensive batteries that may be desired. In various example embodiments of the present general inventive concept, a lithium ion phosphate battery may be used to power the system.

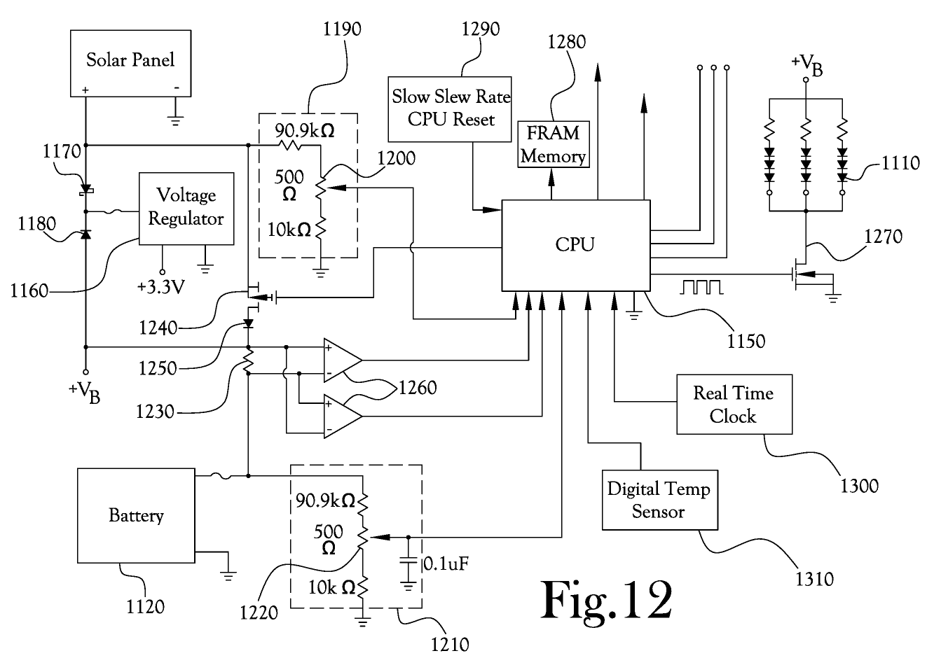

FIG. 12 is a schematic illustration of a solar powered lighting system control circuit according to an example embodiment of the present general inventive concept. The example embodiment control circuit of FIG. 12 may control the power provided from the solar panel 502 and battery 1120 in a way that helps to minimize strain on, and thus increase the life of, the battery 1120. The power from the solar panel 502 and battery 1120 is used to power the light 1110, which may in the descriptions herein refer to a plurality of lights, as well as the control circuitry itself. It will be understood that various example embodiments of the lighting system and the control circuit illustrated in FIG. 12 may include more or fewer components than those illustrated in FIG. 12 without departing from the scope of the present general inventive concept. Also, various components may be configured differently or substituted with other components to provide functions so as those described herein. In various example embodiments, the control circuit components may be provided on a single printed circuit board (PCB) that may be housed in a weather-proof container to protect against harsh environmental conditions that may be encountered when installed on a post member 101 in a remote location.

The control circuit of the example embodiment illustrated in FIG. 12 includes a controller 1150 configured to be in electrical communication with the solar panel 502 and battery 1120. The controller 1150 may be a CPU configured to perform the various control operations described herein, and may be referred to interchangeably herein as a central processor, central processing unit, central processing circuit, central controller, or simply controller. In various example embodiments the controller 1150 may include one or more onboard A/D converters to perform the analog to digital conversion of various values read and processed in these control operations, so as to reduce a quantity of components in the control circuit 1130. The controller 1150 may also include a pulse width modulator to produce a variable duty cycle, a host of general purpose I/O lines to be used as enable lines for one or more peripheral components as described herein, etc. In this example embodiment the control circuit 1130 is configured to run on approximately 3.3V for low power consumption, but various other example embodiments may be configured to run on different voltage levels. The 3.3V used to power the control circuit 1130 of the present example embodiment is provided by a low power voltage regulator 1160 that is in electrical communication with the solar panel 502 and battery 1120. Thus, there will be a voltage present from the solar panel 502 periodically, such as during sufficiently sunlit conditions, and there will normally always be a voltage present from the battery 1120, subject to the battery 1120 having a charge and the control of the controller 1150. In this example embodiment, the nominal voltage presented to the voltage regulator 1160 from the battery 1120 is approximately 13V, which will be regulated down to 3.3V by the voltage regulator 1160. In conditions in which the sun is up, the voltage presented to the voltage regulator 1160 from the solar panel 502 will be approximately 17-18V. Therefore, during those times there will be a higher voltage available from the solar panel 502 than the battery 1120. In this example embodiment, the path between the solar panel 502 and the voltage regulator 1160 includes a Schottky diode 1170, and the path between the battery 1120 and the voltage regulator 1160 includes a silicon diode 1180. Various example embodiments of the present general inventive concept may employ different typed of diodes to perform the duty of the illustrated diodes 1170 and 1180. The path between the voltage regulator 1160 and the diodes 1170 and 1180 may include a fuse, such as a polyfuse or other resettable fuse, to protect the voltage regulator 1160. The voltage drop across the diode 1170 will typically be approximately 0.2-0.3V when current is flowing from the solar panel 502, compared to the approximate 0.6V voltage drop across the silicon diode 1180, and thus the higher voltage at the solar panel 502 will produce a blocking condition at the silicon diode 1180. Therefore, when the higher voltage is available from the solar panel 502, which means the solar panel 502 voltage exceeds the battery voltage, the battery voltage V_{B} will be blocked from the voltage regulator 1160. In other words, since the silicon diode 1180 is reverse biased due to the higher voltage being present in the solar panel 502, the current from the battery is cut off from voltage regulator 1160, and all of the current to voltage regulator 1160 will be coming from the solar panel 502 during sufficiently sunlit conditions. Therefore, during days with good sunlight, all of the power for the circuitry will generated from the solar panel 502, and no charge from the battery 1120 is consumed. The control circuitry is able to draw power from either the battery 1120 or the solar panel 520, but will draw from the solar panel 502 preferentially, i.e., when sunlight conditions allow it. The solar panel 502 can be producing a voltage of lower than the 13V nominally present at the battery and still be powering the voltage regulator as long as possible, even into dusk conditions. The controller 1150 controls the control circuitry to charge the battery 1120 during the day, and to use power produced by the battery 1120 to power the light 1110 and control circuitry 1130.

One of the operations that is performed by the control circuit 1130 is obtaining the solar panel 502 voltage and the battery 1120 voltage, and the current being used to charge the battery 1120. During night or other similar conditions in which there is not sufficient sunlight to produce a usable voltage from the solar panel 502, the current being drawn from the battery 1120 to charge the control circuit and light 1110 is measured. All of these currents and voltages are monitored and may be recorded, as will be described herein. When tracking the currents from the solar panel 502 and battery 1120, a charge current from the solar panel 502 to the battery 1120 may be considered a positive current, or positive value, and a current from the battery to power the light 1110 and control circuitry 1130 may be considered a negative current, or negative value. The controller 1150 is configured with an accumulator, e.g., a counter, that keeps a running track of the charge being reduced. Thus, a charging current is added to the value representing the total charge, and current being drawn from the battery 1120 is subtracted from the value. For measuring voltages, an onboard A/D converter on the controller 1150 is employed to convert a measured analog voltage into a digital value. As illustrated in FIG. 12, a voltage divider 1190 is provided between the solar panel 502 and the controller 1150 to obtain a value representative of the solar panel voltage. The voltage divider 1190 of this example embodiment includes a 500 Ω trim pot 1200 in electrical communication with the controller 1150, a 90.9kΩ resistor between the solar panel 502 and the trim pot 1200, and a 10kΩ between the trim pot 1200 and ground. The value produced by the voltage divider 1190 is a representative value of the solar panel 502 voltage. Since the controller 1150 of the present example embodiment can't measure directly the approximate 17V being generated at the solar panel 502, as it is outside the 3.3V supply range of the controller 1150, the measured valued is limited to a lower value. In this example embodiment, the measured value presented to the onboard A/D converter is limited to approximately 2.5V. Thus, the sampled voltage is kept between 0 and 2.5V to produce a valid representative value. In this example embodiment, the trim pot 1200 is used in the voltage divider 1190 to compensate for a case in which the measured voltage varies from the actual value that may be measured from a precision voltage meter, due to offsets and/or imperfections in the A/D converter. With the inclusion of the trim pot 1200, the circuitry can be calibrated by comparing precision meter readings with internal A/D converter readings. The trim pot 1200 can be adjusted to make the converted value more precisely indicate the actual produced voltage, and thus make the value conform to that measured with a precision meter. A voltage divider 1210 is also provided to aid in the measurement of the voltage of the battery 1120, and configured to be in electrical communication with the battery 1120 and the controller 1150. The voltage divider 1210 is provided with a 500 Ω trim pot 1220 in electrical communication with the controller 1150, a 90.0kΩ resistor between the trim pot 1220 and battery 1120, and a 10kΩ resistor between the trim pot 1220 and ground. As with the solar panel 502, this is used because the approximate 13V nominal voltage at the battery is not an appropriate level to be directly presented to an A/D converter onboards the controller 1150. Thus, the representative voltage values provided to the controller 1150 by the voltage dividers 1190 and 1210 are scaled down from the actual voltages of the respective solar panel 502 and battery 1120, but are still proportional and linear, and therefore simply a percentage of the actual total voltages. The trim pots of the voltage dividers 1190 and 1210 can be used to improve the accuracy of the measured voltages to, for example, within one significant bit of the A/D converter.

The control circuitry 1130 of this example embodiment of the present general inventive concept is also configured to measure current produced by the solar panel 502 and battery 1120. A current sense resistor 1230, which is a current moderating resistor, is configured to be in electrical communication with the solar panel 502 and the battery 1120, and also with the controller 1150. A PMOS switch 1240 and blocking diode 1250 are provided on the path between the solar panel 502 and the current sense resistor 1230. The source of the PMOS switch 1230 is tied to the positive terminal of the solar panel 502, and the drain is connected to the current sense resistor 1240 through the blocking diode 1250, which is connected to the battery 1120. When the battery 1120 is being charged by the solar panel 502, this is the path through which the main current flows. The controller 1150 controls the PMOS switch 1240 to turn the charging operation on and off. The solar generated current is allowed to flow to the battery to charge the battery, and is turned off when the battery 1120 is powering the control circuitry 1130 and light 503. The current sense resistor 1230 of this example embodiment is configured to have a very small value, such as 0.05 Ω, to improve the efficiency of the control circuit 1130. Thus, a large amount of current is not lost in the measurement, and a voltage drop across the resistor 1230 that would cause heat and waste is minimized. The value of the current sense resistor 1230 is large enough to produce an easily measurable and accurate value, without being detrimental to the efficiency of the system. Both sides of the resistor 1230 are subjected to a relatively large voltage. When the PMOS switch 1240 is controlled to be on, and the battery 1120 is therefore being charged, there is a small voltage drop across the resistor 1230, and both sides of the resistor 1230 are high in voltage relative to ground. When the PMOS switch 1240 is on the voltage will be close to the solar panel 502 voltage, and when off the voltage will be close to the battery 1120 voltage, but still significantly above ground, and therefore will be converted to a representative value before being presented to an A/D converter onboard the controller 1150. A pair of differential amplifiers 1260 are configured to measure the voltage across the current sense resistor 1230. The differential amplifiers 1260 are configured to be high side current amplifiers that that measure the difference between one side of the current sense resistor 1230 and the other, and that is used to measure the voltage across the current sense resistor 1230. The measured voltage will be a small voltage, typically in the range of 10's of millivolts. The two differential amplifiers 1260 are provided so that the positive inputs of each of the differential amplifiers 1260 can be respectively tied to each side of the current sense resistor 1230. In various example embodiments, the differential amplifiers 1260 have a fixed gain of 25. When a current is flowing from the solar panel 502 into the battery 1120, a first voltage drop will be produced that creates a positive on the “top” (relative to the illustration of FIG. 12) side of the current sense resistor 1230. When the current is flowing out of the battery 1120, i.e., during use of the battery to run the lights, then the voltage drop will be oriented in the opposite direction, with a positive on the “bottom” side of the current sense resistor 1230. Thus, by using the two differential amplifiers 1260 connected as described, the current from the solar panel 502 is represented to the controller 1150 as a charging current, and the current from the battery is represented to the controller 1150 as a discharging current. As the voltages are sampled, the discharging current is subtracted from the charging current to determine the net current going into the accumulator counter inside the controller 1150. One value will be added to the charge level being recorded, and the other value will be subtracted, depending on the direction of the current. The differential amplifiers 1260 are provided to add gain to produce a larger and easier to read value when using the low value current sense resistor 1230, and to differentiate between charging and discharging into separate inputs being mathematically combined in the controller 1150.

The gate of the PMOS switch 1240 is controlled by the controller 1150 to be on or off. The gate will not be on all of the time because the battery could be damaged by being overcharged, and because of the possibility of unnecessary leakage current. At night there is no current coming from the solar panel 502, so there's only potential for leakage current back through the blocking diode 1250. So the PMOS switch 1240 provides an additional check to protect against the battery 1120 discharging backwards through the charging path. The control circuit 1130 detects dawn and/or other “bright sun” levels by sampling the voltage at the voltage divider 1190, and the controller 1150 will enable the PMOS switch 1240 to allow the flow of current from the solar panel 502 to the battery 1120 when the solar light is sufficiently bright to begin an acceptable charge current. All of the measure values discussed herein may be recorded by the control circuit 1130 for later access and/or communication. In various example embodiments the controller 1150 will delay the activation of the light 1110, or adjust the power levels of the light 1110, according to charging levels and periods. For example, the controller 1150 may be configured to require a certain amount of “bright” sun, or some predetermined period of a threshold solar panel voltage, before the possibility of turning the light 1110 on at night. The timing of the light 1110 being activated may be limited by the controller 1150 to a certain predetermined time, such as five hours, to avoid consuming power at times at which no people are likely to be in the vicinity. The monitoring of the voltage levels through the operation of the voltage dividers 1190 and 1210 provides values to the controller 1150 that indicate various conditions through recognized value levels, such as, for example, bright sun, dim sun, no sun, etc. Since the controller 1150 can recognize when sundown occurs, it can control the light 1110 to be turned on.

The control circuitry 1130 includes an NMOS field effect transistor switch 1270 between the light 1110 and ground, and in electrical communication with the controller 1150. The drain circuit of the NMOS switch 1270 is tied to the light 1110, which is illustrated herein by a plurality of LEDs with respective series resistance values, and so that the controller 1150 controls the light 1110 to come on by enabling the switch 1270 to pull to ground. In various example embodiments of the present general inventive concept the controller 1150 uses a variable duty cycle to chop the voltage to adjust the brightness of the light 1110. For example, with a 50% square wave, the light would be 50% as bright, as it will be on half the time by average. The illumination of the light 1110 is a linear function of the current. A steady current would cause the lights to be on all of the time that they are powered. Thus, in contrast to conventional systems which simply run lights at full brightness regardless of weather/charge conditions, in various example embodiments of the present general inventive concept the lights 1110 can be run at a lower brightness on a cloudy day, or during a cloudy week, to protect the battery from being overworked on a low charge. The resistor values illustrated with the LEDs provides the balance of the applied 13 volts that is not covered by the voltage drop across the respective LEDs.

A real time clock 1300 is provided to supply time information and the like to the controller 1150. In various example embodiments the real time clock 1300 may be configured to generate an accurate time base with a one second period, and can be initialized for a particular calendar day, century, hour minute, second, etc. Once set, the clock 1300 will be fairly accurate for an extended length of time, and provides the controller 1150 with timing information to program certain times for lights to come on, as well as time stamp information for data recorded by the system, and can be used to determine when to sense/record time dictated data. In other various example embodiments, a simple dusk to dawn cycle may be utilized instead. A ferro-electric random access memory (FRAM) 1280 is provided in electrical communication with the controller 1150 to store data regarding to voltage and current levels, sensed environmental data, communication protocols, and the like. While other various example embodiments may employ different types of memory storage, the FRAM 1280 has a cell by cell backup that is non-volatile storage. One advantage to using the FRAM 1280 is that there is a minimal delay in writing data to the memory compared to a typical EPROM, so less power and time is used to record the desired data. As the FRAM 1280 is substantially instantaneously writable, the controller 1150 is not slowed during the writing operation. Also, upon power-down the FRAM 1280 automatically saves the information, so loss of power won't affect the date being recorded. The RAM data is backed up. Such benefits may be worth the extra cost of the FRAM in various applications of the present general inventive concept. A slow slew rate CPU reset 1290 is provided to the control circuit 1130 in communication with the controller 1150 to reset the controller 1150 in the even of losing power sufficiently to shut down the system. The slow slew rate reset 1290 helps to guard against brownouts and the uncertainty that would otherwise be encountered when starting the system up after a long period of insufficient light being provided to the solar panel 502. For instance, if a storm, such as a hurricane, were severe and prolonged enough that the solar panel 502 was deprived of light for a period of time so long that the entire system shut down, the reset 1290, upon sunlight returning, resets the controller 1150 with a proper reset pulse in the event of a slow rise return to power. Otherwise, a slow rise of voltage may not reset the controller 1150 properly. A digital temperature sensor 1310 may be provided to the control circuit 1130 to provide temperature data to be stored along with other environmental data. A line to the immediate right of the FRAM memory 1280 represents a serial port for a BLUETOOTH® or cellular communication module to allow communication with the controller 1150. The serial port is configured to receive and transmit data, and includes a signaling line to indicate that data is available. As discussed herein, such communication may allow for the transfer of data recorded by the control circuitry 1130, as well as reconfiguring of firmware and the like that is used in the operation of the control circuitry 1130 and/or overall lighting system. An SPI port for any other external sensors or other types of peripheral devices 1140 is illustrated to the right of the serial port used for BLUETOOTH® and/or cellular communication, and a plurality of device enable lines to enable the peripheral devices are illustrated at the right side of the controller 1150. Such peripheral devices, like external sensors, may all share the SPI port bus, and will be enabled by the controller 1150 through the respective device enable lines. Each such device will have one enable line, and only one of the enable lines will be pulled low by the controller 1150 at any given time, and will therefore be able to use the SPI port bus. Various example embodiments of the present general inventive concept may include a host of different peripheral devices, such as an infrared sensor to sense the presence of passersby, a lightning detector, and so on. Various types of weather detection sensors may be provided, and weather data such as electrical field changes indicating impending lightning strikes may be shared with weather services and other organizations through the communications module provided to the system. Lighting related weather data may be sensed by a field mill provided to the lighting system, and the field mill may be configured as a separately enclosed unit with dedicated circuitry that communicates with the controller 1150 through the SPI port bus. Such data may be invaluable to other organizations for predicting future weather patterns, warning certain areas of approaching sever weather, and so on. Such sensors will be enabled by the enable lines to be able to transmit data through the SPI bus to be recorded by the control circuitry 1130.

In various example embodiments of the present general inventive concept, the controller 1150 may control the battery voltage supplied to the lights to be cut off if the battery voltage falls below a threshold value, such as, for example, 12.79V, that is too low for the light 1110 to be powered for the predetermined lighting time period without potentially causing damage to the battery 1120. The controller 1150 may control the light 1110 to be operated at half-brightness or another decreased level in response to the battery voltage falling below another threshold value, such as, for example 13.07V, that indicates that the battery is still sufficiently charged, but lower than optimal. If the battery voltage falls below the light cutoff voltage, the lights will not be turned on again until the battery is charged at least to above the reduced brightness threshold. In various example embodiments of the present general inventive concept the controller 1150 monitors the voltage level of the battery to as to control charging according to upper and lover hysteresis thresholds. Charging above a hysteresis upper threshold has no charge benefit, and can only harm the battery. The hysteresis lower threshold, under which the battery voltage would then have to drop before being charged again, is provided to prevent a constant up and down chatter of only having a hysteresis upper threshold. Otherwise the charging might be turned on and off almost constantly with different cycles in the vicinity of the hysteresis upper threshold. This produce “chatter”, which may interfere with cellular of other RF sensitive instrumentation, along with being detrimental to the health of the battery. Therefore, by adhering to hysteresis upper and lower thresholds to determine the enabling and disabling of the charging operation, such chatter can be prevented. Over time, the battery 1120 will age and begin losing efficacy, so the controller 1150 may monitor, for example, maxcharge, minimum maxcharge, and maximum mincharge values that indicate maximum and minimum amounts of maximum and minimum battery charge hours that will be accepted. Although the solar powered lighting system illustrated in FIGS. 11A-12 includes a single battery, a plurality of batteries may be employed in different applications of the present general inventive concept.

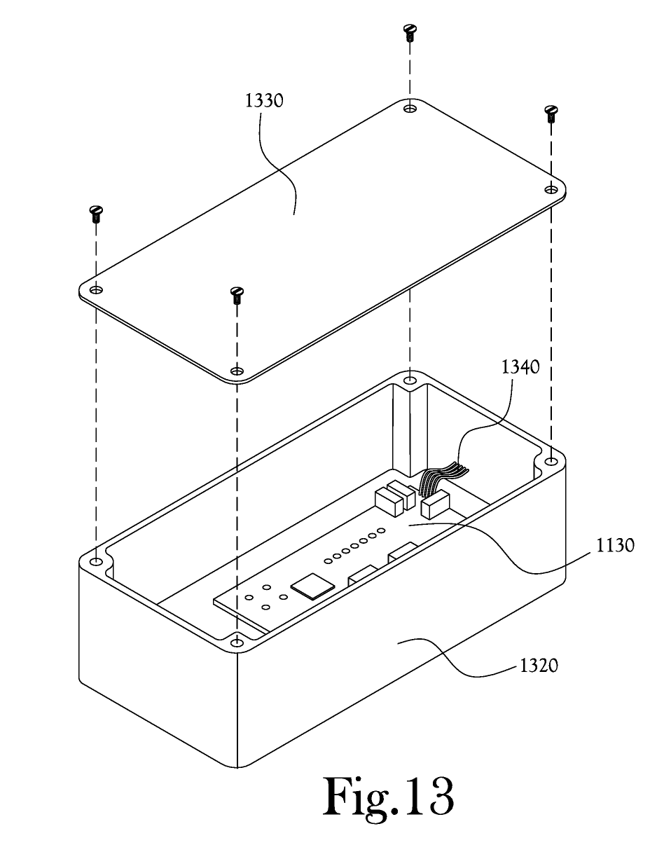

FIG. 13 illustrates a protective casing for a solar powered lighting system control circuit according to an example embodiment of the present general inventive concept. In the example embodiment illustrated in FIG. 13, the solar powered lighting system controller circuitry 1130 is configured on a single PCB and arranged in a protective case 1320 having a lid 1330 that is configured to be adhered to the lower portion of the case 1320 by a plurality of screws respectively provided at each corner of the lid. Various example embodiments may employ a host of different configurations and/or adhering members to seal the controller circuitry 1130 inside the protective case 1320, and may employ a sealing member or substance between the contacting areas of the lid 1330 and the lower portion of the case 1320 to weather-proof the case and protect the controller circuitry 1130 from environmental conditions. It is important to provide such protection to the controller circuitry in applications in which the system is installed in remote locations that will not be scheduled for maintenance for long periods of time. The case 1320 is provided with a through-port 1340 to allow serial bus lines, enable lines, and other such communication links to peripheral devices provided to the system. With such an arrangement, the controller circuitry 1130 can be provided above the top member 501 of a system such as that illustrated in FIG. 11A so as to be out of sight, as well as inaccessible, to passersby. Even in example embodiments in which the top member is configured as a sealed enclosure, such a protective case 1320 may be valuable inside the sealed enclosure to protect against humidity and other issues. Enclosed top members provide aesthetically pleasing designs by hiding the components and wiring of the solar powered lighting system, and also provide protection against weather and vandalism. In various example embodiments, one or more of the translucent windows may be provided to such an enclose top member itself, so that one or more lights may be arranged inside the top member along with, or in lieu of, placing lights and windows in the post member. Such top member windows could also be RF transparent to more readily accommodate cellular communication signals to antennae provided therein.

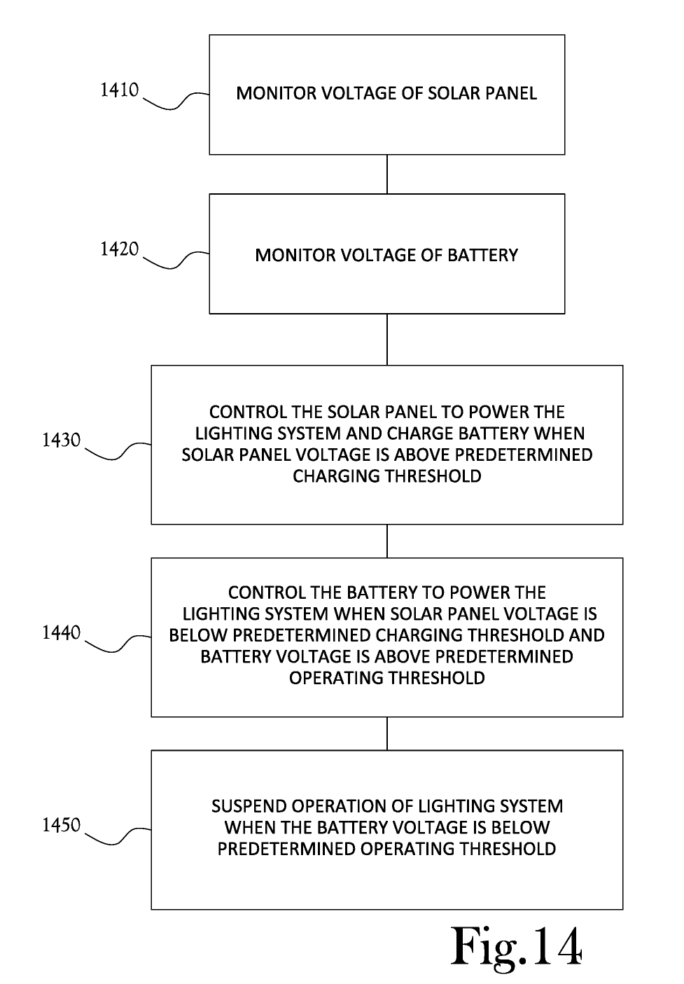

FIG. 14 illustrates a method of controlling a solar power lighting system according to an example embodiment of the present general inventive concept. The operations illustrated in FIG. 14 have been described herein in regard to many of the physical components of the lighting system, and to the control circuitry illustrated in FIG. 12. These and other operations described herein may be performed by firmware and/or software controlling the various different components discussed herein, and the operations of this example embodiment are not necessarily performed in the order presented in FIG. 14. In operation 1410, the various control circuitry monitors the voltage being generated at the photovoltaic solar panel, and in operation 1420 the control circuitry monitors the voltage present at the battery of the system. In operation 1430 the system is controlled to allow current from the solar panel to be transmitted to the battery to charge the battery to a desired level when the solar panel voltage is above a predetermined charging threshold that indicates a desirable charging period. In operation 1440 the system is controlled to allow the battery to power the lights of the lighting system when the solar panel voltage is below a predetermined charging threshold which indicates that charging is desirable, and when the battery voltage is above a predetermined minimum operating threshold. Timing information monitored by the control circuitry may also be incorporated into the operation of determining when the battery is to power the lights. The duty cycle of the lights may also be controlled according to a charge level of the battery. In operation 1450 the system is controlled to suspend operation of the lighting system when the battery voltage is below a predetermined operating threshold. The system may also be controlled to have the battery cease to provide power to the control circuitry itself if a certain minimum processing voltage threshold is not present. Various other example embodiments may provide a host of additional and or different operations without departing from the scope of the present general inventive concept. For example, various example embodiments of the present general inventive concept include monitoring environmental conditions in the area in which the lighting system is located, monitoring the number of passersby, and so on. This sensed data, such as electric field data related to coming lightning strikes, can be stored and later communicated to a remote location using a cellular network. Such data could be invaluable to organizations like the weather services. Additionally, the cellular network can be used to remotely control system parameters such as the lighting schedule, monitor the overall health of the system, and so on. In some example embodiments, a local network of units having a post member provided with the solar powered lighting system may communicate with one another by BLUETOOTH® or other wireless methods, while one or several of the overall units will be responsible for communicating all of the collected data through a cellular network to a remote location. The data coming from each of the particular stations can be identification coded to associate the data with the particular stations, and by having one or several of the stations handle the cellular communications for the whole network, costs may be reduced.

Various example embodiments of the present general inventive concept may provide components and methods of performing a host of other functions with valuable benefits compared to conventional methods. Many of the methods described herein can be implemented with firmware that may be described herein in terms of firmware modules. For example, the controller circuitry may be controlled to perform user authorization functions with a user using BLUETOOTH® Low Energy (BLE) communication methods. In an example embodiment, the user's phone may connect via BLUETOOTH® to the solar powered lighting system (which may be referred to herein as a “station” or “lighting system station”), wherein the user's phone will issue an authorization request. The controller will generate a random token and send the token and station number to the user's phone. The user's phone will send a signature request to a server that is part of a group of station management servers. The management servers check to see if the user is authorized to communicate with the station and, if the user is authorized, the server will sign the request. The user's phone will then send the signed authorization request to the station, which will verify the request and, if valid, allow further communication with the station for the duration of the communication session. A cloud version of this process will not use BLUETOOTH® or a user's phone in order to send and access data. Authentication can be handled by https client and server certificates or digital signatures of packetized data. The station may initiate the communication to the server directly limiting potential attack vectors on the individual stations.

In various example embodiments of the present general inventive concept, the controller circuitry may include firmware having a plurality of code modules. A battery module may be responsible for the charging of the battery and battery health monitoring. If battery voltage and current are above cutoff thresholds or there is no sunlight detected it may turn off battery charging. If battery has low voltage and there is bright sunlight detected the module may attempt to charge the battery. The module may also record data about the battery health and state of charge. A BLUETOOTH® module may handle the interprocessor communication between the communication unit and the bluetooth radio module. It may configure the BLE radio on startup, keep track of session and BLE GATT events, and transform data passed to and from it by the Communication module into the native format used by the Bluetooth radio module. A communication module may handle the parsing of MessagePack data that is sent to the station from a phone. It also may assemble MessagePack data that is sent to the phone, and may prevent access to the station unless proper authorization is received. A data recorder module may handle the recording of the station health data and statistics. A light module may handle the light power levels and run duration. When there is no sunlight detected and the lights are readied it may turn on the lights. If it detects that there has been sunlight for the last past hour it may ready the lights for use again. A random module may provide rudimentary random number generation and seeding for the other modules. A serial port module may handle interprocessor serial port communication and serial port event interrupts. A solar module may monitor the voltage of the solar panels and provide solar data for the other modules. The solar module may detect whether there is sunlight, bright sunlight, no sunlight, and if it has seen sunlight for the last hour. A time module may monitor the realtime clock and provide an interface to read and set the RTC. It may also provide time events for the other modules (daily, hourly, minutes, seconds). Several other miscellaneous modules may be included such as an ADC module to provide an interface to the A/D converter, a memory module to provide an interface to the non-volatile memory, and RTC module to provide an interface to the real time clock, an SPI module to provide an interface to interprocessor SPI communication, and a temp sensor module to provide an interface to the station's temperature sensor. In normal operation, an initialization procedure may include initializing communication unit ports, initializing inter processor communication (serial port, SPI, etc.), initializing the A/D converter(s), including reading stored battery voltage A/D converter offset for a more accurate reading of the battery voltage, initializing the communication module and BLE device, initializing the lights module, including initializing the lights to off and reading a stored default run time if set, initializing the clock, including initializing the date from the real time clock and starting a failsafe timer to used in the event that the real time clock fails, and setting callbacks for on seconds, minutes, and hours changed. The main execution loop may include updating seed for pseudorandom number generator, reading date and time from RTC, checking if time has changed, and executing callbacks for on seconds, minutes, hours changed appropriately (If seconds has not changed for 5 seconds switch to failsafe timer), reading current battery voltage with applied offset and averaging filter. If the current battery charge is greater or equal to the max supported battery charge, or if the current battery voltage has passed an upper voltage threshold the battery charging may be turned off. Additionally, if the upper voltage threshold is reached and the current battery charge fails a sanity check, the battery charge may be reset to a value appropriate for the voltage. This will help the program correct itself if the battery charge tracking is interrupted due to a power failure. The serial port transmit buffers may be checked to see if they are not empty, if data is available, it may be transmitted through the serial ports. The main execution loop may also include decoding any pending messages from the BLUETOOTH® module. During a second loop the firmware may control the control circuitry to read the voltage of the solar panels with an applied averaging filter. Data may also be collected to determine if the unit has seen sunlight for the past hour. The past second of charge may be obtained by reading the difference between battery charging current and the discharging current, and this value may then be integrated to track milliamp seconds. Hourly peak current may also be tracked. If the battery voltage is below the lower charging threshold and there is bright sunlight detected and the battery is not currently charging, charging may be enabled for the battery. If the battery is currently charging and there is no sunlight detected the battery charging may be turned off. Additionally, if the lower voltage threshold is reached and the current battery charge fails a sanity check, the battery charge may be reset to a value appropriate for the voltage. This will help the program correct itself if the battery charge tracking is interrupted due to a power failure. If darkness has been detected, and the lights have runtime remaining, the lights may be set to a PWM level appropriate for the amount of battery charge left in the GWOC unit and one second of runtime is decremented. If there is no light runtime left then the lights may be turned off. If there has been sunlight detected for the past hour then the runtime for the lights may be reset/rearmed. If there is time remaining in the BLUETOOTH® lockout timer (this may be set if repeated failed attempts to access the unit are detected), then the BLUETOOTH® module may be disabled and the timer may be decremented by one second. If there is no lockout timer and there is sunlight detected then the BLUETOOTH® module may be enabled. If darkness has been detected, and there is time remaining in the BLUETOOTH® runtime after dark timer, then the BLUETOOTH® module may be enabled, and the timer may be decremented by one second. Once the timer reaches zero the BLUETOOTH® module may be turned off for the night, until the unit detects sunlight for the past hour and the timer is reset/rearmed and the BLUETOOTH® module is enabled. An hourly loop may include recording the current time, record ID, battery charge in mAh, hourly battery peak current, current battery voltage, and temperature every hour in the unit's on board memory. Battery peak current may be reset. At midnight a new data record ID may be generated.

The cloud version acts similarly to the standard operations described above, but includes some differences. The cloud version communicates directly with the management console servers via built in cell phone transceivers. Data is not saved on the device but is uploaded to the servers at predetermined time intervals. Data can be aggregated for better power/data efficiency. Configuration updates are pushed to the units when the device contacts the server. The cloud versions can also be outfitted with sensors that can send real time updates of sensor data events (e.g. Field mill monitoring electrical data from an advancing thunderstorm front). Authentication in the cloud version may not use BLUETOOTH® or a user's phone in order to send and access data. Authentication can be handled by https client and server certificates or digital signatures of packetized data. The station (unit) may initiate the communication to the server directly, limiting potential attack vectors on the individual cloud units. Benefits of the cloud version include data not being stored on a device requiring users to collect data in the field. Device data and system health can be accessed from anywhere with an internet connection. Device configuration can be done remotely at anytime. RTC clock setup on site is not required. Device configuration can be automatically scheduled from management console servers (useful for different seasons, installed location hours, etc.). Real time updates are available for specialty sensors. The GPS location of a unit can be accessed (useful for device identification, data aggregation, etc). Device failures can be identified by the management console servers (as long as the device can still communicate with servers).

The present general inventive concept provides a custom charging circuit with protections to limit battery overcharging and over-discharging in order to optimally extend battery lifetime, which may be incorporated with the structure of the recycling and trash receptacles described herein. The solar powered structures may serve as a powered platform and support housing for various sensors as described herein. Examples of sensors that can be incorporated into these example systems include passive IR sensors that detect body heat of park patrons. When a body is detected this information can be used to count park users walking by a particular unit situated next to a pathway. It can also trigger an increase in brightness level of the lights at night for a short time to facilitate better visibility for the person walking by. Another class of sensors are weather sensors including temperature, and humidity sensor and electric field sensors. Early detection of rising electric field locally can be used to warn of imminent lightning strike with a horn or flashing light on the unit. Electric field may be measured with a field mill electrometer mounted proximate the top of the lighting structure. Multiple units with attached field mills, configured in a linear arrangement and perpendicular to usual frontal boundary movement, can be used to gather useful data about a cloud or thunderstorm cell or entire weather front as it moves past the linear array of units. The aggregate data will effectively paint a picture of the charge distribution in the clouds affording weather service personnel a valuable tool for prediction of lightning hazard or for research. The control circuitry also features wireless communication, including, but not limited to, low power BLUETOOTH® BLE or Cellular. The BLUETOOTH® units may save data about charge history and solar cell and battery performance as well as board temperature. The BLUETOOTH® connection allows a technician or park personnel to download diagnostic information records of the past year. Additionally, changes in desired light onset and duration timing, and intensity, can be uploaded. Limited on time of the BLE module saves power and limits hacking attempts. Cryptographic methods may be employed to verify authorized users. Cellular enabled units may connect to a predetermined fixed remote server address periodically (could be daily or every few minutes) with the rate determined by the application. Updating the light schedule and sending the performance record could be done daily to minimize power impact since a cellular transmitter uses around 1.2A current while transmitting, vs approximately 16 mA for BLE modules. Some applications such as realtime monitoring the cloud electric field might require more rapid updates to the server, but these timings are configurable and adaptable to the purpose. Cellular units may also include a hardware chip to assist in verifying RSA algorithm for digitally signed tokens. This chip may be connected by a short cable using an I2C or SPI bus, and may provide the dedicated math support for the crypto authentication of the server. Regarding battery charge management, the controller may have a low value (0.05 Ohm) resistor that the solar charging current and battery discharging current must flow through. Precision differential amplifiers may measure the voltage across this resistor to determine the current, which may be integrated at one second intervals onto a software accumulator where it represents the charge in mA-seconds. Battery initial charge level may be input as a starting point, and the circuit and software may keep a running total of the charge going in as well as the charge consumed by the lights and other attached sensors. Knowing the battery state of charge allows the user (and controller) to predict how much after dark light time can be supported. The schedule of lighting, such as the onset of lighting after dark and what sky condition is called “dark”, and duration of lighting are programmable and may be updated wirelessly. One benefit of the controller is protecting the battery from unwanted detrimental effects of overcharging and over discharging. If the battery terminal voltage is above or below programmed limits, the charging is disconnected, or light timing and intensity can be reduced to levels supportable by the state of the battery. Using a switching mode controller for efficiency and matching peak solar voltages to nominal 13V battery voltage can mitigate interference with cellular and BLE radios, and GPS and electric field instrumentation. Good efficiency is still maintained with the low quiescent current of the controller (about 8 mA) and the highly efficient switching variable duty cycle LED waveform which may control LED brightness with a frame rate of nominally 3.6 KHz. A built in software data recorder may save hourly records of battery state of charge, voltages, and currents from solar cells and board temperature. The data records may be communicated wirelessly to a central server, and may be accessed easily by web browser based software. Various example embodiments may use batteries in the units that are conventional lead acid cells, but other units may use a Lithium Iron Phosphate battery which has improved charge retention, and much better performance at high temperatures typically found in summer in the enclosed GWOC housing. They also have very low risk of fire at high temperatures, in contrast with other Lithium battery technologies, and safety is an important aspect of the control circuit of the present general inventive concept. Thus, the various example embodiment systems utilizing the present general inventive concept can be used as a powered sensor and communication platform; can have a LiFeP battery for high efficiency, long life, high temp resistance, and safety; can have the ability to use internally mounted BLE or Cellular transmitters with no visible or external antennas; can have cellular componentry mounted in the central column, wherein RF gets through frosted white plexiglass windows or other translucent members (which keeps transceivers away from direct rain as well as hidden from vandals); can have a controller with low RFI due to no high current high frequency switching with inductors; can have a built in data recorder to show state of health of battery and solar cell; can wirelessly read data, and update light schedule; can have automatic fallback to lower intensity, or not running lights at all, if there is an insufficient battery charge; can have failsafe “seconds” timer based on CPU clock oscillator checks on the normal Real Time Clock hardware chip in case the controller chip fails to restart after power outage or brownout or due to high humidity level; and so on. An optional electric field mill electrometer fitted to the unit can be situated in remote areas or parks without regard to grid power since the solar and battery combination with smart controller can provide power, and cellular communication can send data to central server for prediction or research.

Therefore, solar powered lighting systems can be provided that can also perform novel and important data collection. The data can be downloaded periodically with the BLUETOOTH® or cellular connectivity. Not just controlling the system with the cellular connectivity, but being able to download all the charge data, the voltage data, etc., allows the system to provide information about the health of the battery, solar panels, unit, etc., as well as what kind of charge is being collected at that particular location, due to shadows and whatnot. The system can send information regarding a problem, if the current flow is not what is expected, maybe a light has gone bad, maybe a battery has gone bad. A wealth of information about the instrumentation is available from the crude data, such as temperature, charge, when lights came on, when the sufficient bright light charge started each day, etc. This information may be recorded for every day that the unit functions.

The control circuitry of the present general inventive concept allows the use of a lithium iron phosphate battery (LiFePO4) that is more expensive than a typical lead acid battery, but which is much better and long lasting when used with this control circuitry. Cycling at high discharge/charge rates at temperature extremes is not a good idea for most battery technologies. For sealed led acid (SLA) batteries, each 8 degrees above 23 degrees Celsius cuts life (which is pretty bad to begin with) in half. At 55 degrees Celsius life of an SLA is 40 cycles (“Life” is defined at 80% of initial capacity for a LiFeO)4 and 60% for an SLA). A LiFePO4 battery will have a life of about 1000 cycles at 55 degrees Celsius. Unlike SLA, charging/discharging a LiFePO4 does not heat the battery. Maintaining the state of charge of the battery so that it doesn't get under-charged or over-charged is highly beneficial in protecting the battery's health. Example embodiments of the present general inventive concept sacrifice the powering of the light in some situation to protect the battery. In other words, the lights may not be run if it would hurt the battery. Also collecting data about the charge, voltage, and so forth, and having it available to download wirelessly, helps to protect the battery's health.

Various example embodiments of the present general inventive concept may provide a solar powered lighting system including one or more lights, a battery configured to selectively power the one or more lights, a solar panel configured to selectively charge the battery, and a system control circuit to monitor voltage levels of the battery and the solar panel, to control the battery to power the one or more lights according to the voltage level of the battery, and to control the solar panel to charge the battery according to the voltage level of the solar panel. The system control circuit may be configured to be selectively powered by the solar panel and the battery. The system control circuit may include a central controller configured to control the battery and solar panel according to the voltage levels of the battery and solar panel. The system control circuit may further include a voltage regulator configured to selectively convert the voltage level of the battery or the solar panel to a lower voltage used to power the system control circuit. The system control circuit may further include a first voltage divider to sense the voltage level of the solar panel and to generate and communicate a reduced representative solar panel voltage level to the central controller. The system control circuit may further include an analog to digital converter to convert the representative solar panel voltage to a digital value to be processed by the central controller. The system control circuit may further include a second voltage divider to sense the voltage level of the battery and to generate and communicate a reduced representative battery voltage level to the central controller. The the system control circuit may further include a current sensor configured to be in electrical communication with the solar panel, battery, and central controller, configured to sense a current level of current transmitted from the solar panel and battery, and to generate and communicate a representative current level to the central controller. The current sensor may include a current sense resistor in electrical communication with the solar panel and battery to sense current from the solar panel and battery, and a pair of differential amplifiers arranged with positive inputs respectively provided to different ends of the current sense resistor, and configured to measure the voltage across the current sense resistor to generate and communicate signals to the central controller indicating whether the current is a battery charging or discharging current. The system control circuit may further include a switch and blocking diode between the current sensor and the solar panel to block a battery discharging current from the solar panel, the switch configured to be selectively opened and closed by the central controller. The system may further include a switch in electrical communication with the central controller and the one or more lights, and configured to control power supplied to the one or more lights according to a duty cycle applied by the central controller. The system may further include one or more sensor components in electrical communication with the central controller to sense environmental conditions at a location of the solar powered lighting system, and a memory configured to store environmental condition signals from the one or more sensor components. The system may further include a communication module configured to receive system access signals from a remote location, and to communicate environmental condition data and/or solar powered lighting system operational data to the remote location. The one or more sensor components may include a lightning detector. The solar powered lighting system may be arranged proximate a top end of a post member configured to support a refuse container at a bottom end thereof.

Various example embodiments of the present general inventive concept may provide a method of controlling a solar powered lighting system, the method including monitoring a voltage level of a solar panel in the solar powered lighting system, monitoring a voltage level of a battery in the solar powered lighting system, controlling the solar panel to charge the battery when the voltage level of the solar panel is above a predetermined charging threshold, controlling the battery to power one or more lights of the solar powered lighting system when the voltage level of the solar panel is below a predetermined charging threshold and the voltage level of the battery is above a predetermined operating threshold, and suspending powering of the one or more lights when the voltage level of the battery is below the predetermined operating threshold. The method may further include adjusting a percentage of the powering of the one or lights when the voltage level of the battery is above a predetermined operating threshold but below a predetermined optimal operating threshold. The method may further include sensing one or more environmental conditions occurring at a location of the solar powered lighting system, storing the sensed one or more environmental conditions in a memory, and communicating the stored one or more environmental conditions to a remote location. The communicating of the stored one or more environmental conditions may be performed through a cellular communication network.

Numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated.

It is noted that the simplified diagrams and drawings included in the present application do not illustrate all the various connections and assemblies of the various components, however, those skilled in the art will understand how to implement such connections and assemblies, based on the illustrated components, figures, and descriptions provided herein, using sound engineering judgment. Numerous variations, modification, and additional embodiments are possible, and, accordingly, all such variations, modifications, and embodiments are to be regarded as being within the spirit and scope of the present general inventive concept.

While the present general inventive concept has been illustrated by description of several example embodiments, and while the illustrative embodiments have been described in detail, it is not the intention of the applicant to restrict or in any way limit the scope of the general inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings. Additional modifications will readily appear to those skilled in the art. Accordingly, departures may be made from such details without departing from the spirit or scope of applicant's general inventive concept.

1. A solar powered lighting system comprising:
one or more lights;
a battery configured to selectively power the one or more lights;
a solar panel configured to selectively charge the battery; and
a system control circuit to monitor voltage levels of the battery and the solar panel, to control the battery to power the one or more lights according to the voltage level of the battery, and to control the solar panel to charge the battery according to the voltage level of the solar panel.

2. The system of claim 1, wherein the system control circuit is configured to be selectively powered by the solar panel and the battery.

3. The system of claim 1, wherein the system control circuit comprises a central controller configured to control the battery and solar panel according to the voltage levels of the battery and solar panel.

4. The system of claim 3, wherein the system control circuit further comprises a voltage regulator configured to selectively convert the voltage level of the battery or the solar panel to a lower voltage used to power the system control circuit.

5. The system of claim 3, wherein the system control circuit further comprises a first voltage divider to sense the voltage level of the solar panel and to generate and communicate a reduced representative solar panel voltage level to the central controller.

6. The system of claim 5, wherein the system control circuit further comprises an analog to digital converter to convert the representative solar panel voltage to a digital value to be processed by the central controller.

7. The system of claim 5, wherein the system control circuit further comprises a second voltage divider to sense the voltage level of the battery and to generate and communicate a reduced representative battery voltage level to the central controller.

8. The system of claim 3, wherein the system control circuit further comprises a current sensor configured to be in electrical communication with the solar panel, battery, and central controller, configured to sense a current level of current transmitted from the solar panel and battery, and to generate and communicate a representative current level to the central controller.

9. The system of claim 8, wherein the current sensor comprises:
a current sense resistor in electrical communication with the solar panel and battery to sense current from the solar panel and battery; and
a pair of differential amplifiers arranged with positive inputs respectively provided to different ends of the current sense resistor, and configured to measure the voltage across the current sense resistor to generate and communicate signals to the central controller indicating whether the current is a battery charging or discharging current.

10. The system of claim 8, wherein the system control circuit further comprises a switch and blocking diode between the current sensor and the solar panel to block a battery discharging current from the solar panel, the switch configured to be selectively opened and closed by the central controller.

11. The system of claim 3, further comprising a switch in electrical communication with the central controller and the one or more lights, and configured to control power supplied to the one or more lights according to a duty cycle applied by the central controller.

12. The system of claim 3, further comprising:
one or more sensor components in electrical communication with the central controller to sense environmental conditions at a location of the solar powered lighting system; and
a memory configured to store environmental condition signals from the one or more sensor components.

14. The system of claim 12, further comprising a communication module configured to receive system access signals from a remote location, and to communicate environmental condition data and/or solar powered lighting system operational data to the remote location.

15. The system of claim 12, wherein the one or more sensor components includes a lightning detector.

16. The system of claim 1, wherein the solar powered lighting system is arranged proximate a top end of a post member configured to support a refuse container at a bottom end thereof.

17. A method of controlling a solar powered lighting system, the method comprising:
monitoring a voltage level of a solar panel in the solar powered lighting system;
monitoring a voltage level of a battery in the solar powered lighting system;
controlling the solar panel to charge the battery when the voltage level of the solar panel is above a predetermined charging threshold;
controlling the battery to power one or more lights of the solar powered lighting system when the voltage level of the solar panel is below a predetermined charging threshold and the voltage level of the battery is above a predetermined operating threshold; and
suspending powering of the one or more lights when the voltage level of the battery is below the predetermined operating threshold.

18. The method of claim 17, further comprising adjusting a percentage of the powering of the one or lights when the voltage level of the battery is above a predetermined operating threshold but below a predetermined optimal operating threshold.

19. The method of claim 17, further comprising:
sensing one or more environmental conditions occurring at a location of the solar powered lighting system;
storing the sensed one or more environmental conditions in a memory; and
communicating the stored one or more environmental conditions to a remote location.

20. The method of claim 19, wherein the communicating of the stored one or more environmental conditions is performed through a cellular communication network.
